(19) United States
(12) Patent Application Publication
(10) Pub. No.: US 2025/0117919 A1
(43) Pub. Date: Apr. 10, 2025

(54) PROCESSING SYSTEM, INSPECTION SYSTEM, PROCESSING METHOD, AND PROGRAM

(71) Applicant: Panasonic Intellectual Property Management Co., Ltd., Osaka (JP)

(72) Inventors: Yuya SUGASAWA, Osaka (JP); Hisaji MURATA, Osaka (JP); Jeffry NAINGGOLAN, Osaka (JP)

(21) Appl. No.: 18/834,461

(22) PCT Filed: Jan. 17, 2023
(86) PCT No.: PCT/JP2023/001143

§ 371 Date: Jul. 30, 2024

(30) Foreign Application Priority Data
Feb. 2, 2022 (JP) 2022-015213

(51) Int. Cl. G06T 7/00

(52) U.S. Cl. CPC G06T 7/0004; G06T 2207/30108

(57) ABSTRACT

A processing system includes an output processor which outputs criterion information applicable to an inspection algorithm. The criterion information includes information about a decision boundary to be defined based on identification results obtained by a plurality of identification algorithms that are different from each other. The decision boundary is used as a criterion for determining, by the inspection algorithm, whether the category of a target is a first category or a second category. Each of the plurality of identification algorithms identifies the category with respect to each of the plurality of image data sets. The decision boundary is a convex hull boundary to be defined based on a set of corresponding identification results, belonging to the identification results, about an image data set, to which a label indicating the second category is attached, out of the plurality of image data sets.

### TECHNICAL FIELD

The present disclosure generally relates to a processing system, an inspection system, a processing method, and a program. More particularly, the present disclosure relates to a processing system, an inspection system, a processing method, and a program, all of which are applicable to image inspection.

### BACKGROUND ART

Patent Literature 1 discloses a decision result output device including a first-stage go/no-go decider, a final-stage go/no-go decider, and a display device. The first-stage go/no-go decider includes a plurality of learned convolutional neural networks (CNNs), each of which outputs the result of a go/no-go decision that has been made on a target covered by input image data. The plurality of learned CNNs serve as mutually different models by entering mutually different types of training data thereto during a machine learning process. The final-stage go/no-go decider decides that the target is a GO (i.e., a non-defective product) only if the results of the go/no-go decisions provided by the plurality of learned CNNs all indicate a GO. That is to say, the final-stage go/no-go decider decides that the target is a NO-GO (i.e., a defective product) if at least one of the results of the go/no-go decisions provided by the plurality of learned CNNs indicates a NO-GO. The final-stage go/no-go decider outputs the result of the go/no-go decision to the display device.

### CITATION LIST

### Patent Literature

Patent Literature 1: JP 2020-46731 A

### SUMMARY OF INVENTION

The decision result output device of Patent Literature 1 decides that the target is a NO-GO if at least one of the results of the go/no-go decisions provided by the plurality of learned CNNs indicates a NO-GO. This may reduce the chances of failing to find a defective target. Nevertheless, the decision result output device of Patent Literature 1 cannot reduce the chances of deciding, by mistake, that an actually non-defective target is a NO-GO (i.e., cannot reduce the rate of incidence of overdetection (hereinafter simply referred to as an “overdetection rate”)), which is a problem with the decision result output device of Patent Literature 1.

In view of the foregoing background, it is therefore an object of the present disclosure to provide a processing system, an inspection system, a processing method, and a program, all of which contribute to reducing the overdetection rate.

A processing system according to an aspect of the present disclosure includes an output processor which outputs criterion information. The criterion information is applicable to an inspection algorithm for use to inspect the target based on image data of a target and thereby identify a category of the target. The criterion information includes information about a decision boundary to be defined based on identification results obtained by a plurality of identification algorithms that are different from each other. The decision boundary is used as a criterion for determining, by the inspection algorithm, whether the category of the target is a first category or a second category. Each of the plurality of identification algorithms identifies, in response to entry of a plurality of image data sets, each representing the target, the category with respect to each of the plurality of image data sets. A label indicating either the first category or the second category is attached to each of the plurality of image data sets. The decision boundary is a convex hull boundary to be defined based on a set of corresponding identification results, belonging to the identification results, about an image data set, to which the label indicating the second category is attached, out of the plurality of image data sets.

An inspection system according to another aspect of the present disclosure performs the inspection algorithm to which the criterion information provided by the above-described processing system is applied. The inspection system includes an image acquirer, an identification result obtainer, and a decider. The image acquirer acquires the image data of the target. The identification result obtainer obtains identification results from the plurality of identification algorithms by entering the image data acquired by the image acquirer into the plurality of identification algorithms. The decider makes a decision about the category based on a positional relationship between the identification results obtained by the identification result obtainer and the convex hull boundary of the criterion information.

A processing method according to still another aspect of the present disclosure includes an output processing step including outputting criterion information. The criterion information is applicable to an inspection algorithm for use to inspect the target based on image data of a target and thereby identify a category of the target. The criterion information includes information about a decision boundary to be defined based on identification results obtained by a plurality of identification algorithms that are different from each other. The decision boundary is used as a criterion for determining, by the inspection algorithm, whether the category of the target is a first category or a second category. Each of the plurality of identification algorithms identifies, in response to entry of a plurality of image data sets, each representing the target, the category with respect to each of the plurality of image data sets. A label indicating either the first category or the second category is attached to each of the plurality of image data sets. The decision boundary is a convex hull boundary to be defined based on a set of corresponding identification results, belonging to the identification results, about an image data set, to which the label indicating the second category is attached, out of the plurality of image data sets.

A program according to yet another aspect of the present disclosure is designed to cause one or more processors to perform the above-described processing method.

### BRIEF DESCRIPTION OF DRAWINGS

FIG. 1 illustrates an overall configuration for a processing system according to an exemplary embodiment;

FIG. 2 illustrates an overall configuration for an inspection system according to the exemplary embodiment;

FIGS. 3A and 3B show a set of data points to illustrate a convex hull boundary for use in the processing system;

FIGS. 4A and 4B are conceptual diagrams illustrating how the inspection system performs an inspection algorithm using the convex hull boundary;

FIGS. 5A and 5B show data points to illustrate an auxiliary set of data points for use in the processing system;

FIG. 5C shows a set of data points to illustrate how an erroneous decision (missing) may be made due to overlearning in a situation where the auxiliary set of data points is not applied;

FIGS. 6A and 6B show a set of data points to illustrate how the processing system makes a margin adjustment with respect to the convex hull boundary;

FIGS. 7A and 7B show a set of data points to illustrate how the inspection system makes a margin adjustment based on the identification results obtained by identification algorithms;

FIG. 8 is a flowchart showing an exemplary operating procedure of the processing system; and

FIG. 9 is a flowchart showing an exemplary operating procedure of the inspection system.

### DESCRIPTION OF EMBODIMENTS

### (1) Overview

The drawings to be referred to in the following description of embodiments are all schematic representations. Thus, the ratio of the dimensions (including thicknesses) of respective constituent elements illustrated on the drawings does not always reflect their actual dimensional ratio.

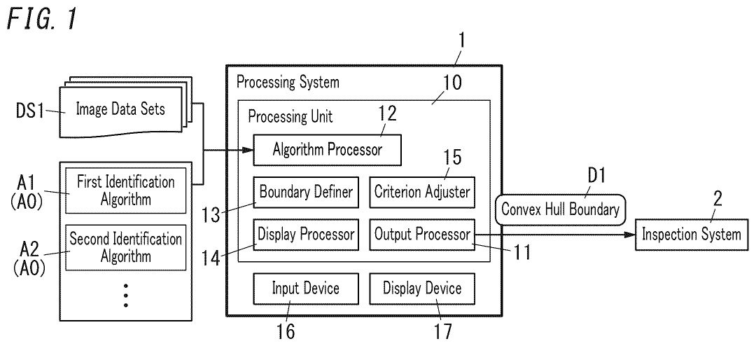

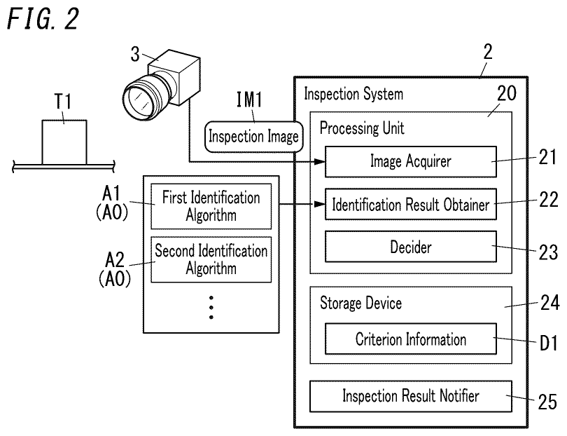

As shown in FIG. 1, a processing system 1 according to this embodiment includes an output processor 11 which outputs criterion information D1. As used herein, the “criterion information D1” refers to information applicable, based on image data IM1 (refer to FIG. 2, in which the image data IM1 is labeled as an “inspection image”) of a target T1 (refer to FIG. 2), to an inspection algorithm for use to inspect the target T1 and thereby identify its category. In this embodiment, an inspection system 2 (refer to FIG. 2) performs the inspection algorithm. The processing system 1 and the inspection system 2 may be integrated together and provided as a single integrated system.

The target T1 as used herein refers to a product (or a semi-finished product) manufactured at a facility such as a factory and may be any type of product without limitation. The inspection system 2 may be used, for example, in an inspection step of inspecting the appearance (on an image) of the target T1. In this embodiment, the “category” may be, for example, a category indicating whether the appearance of the target T1 is defective or non-defective. The appearance of the target T1 is determined (recognized), through an image inspection performed by the inspection system 2, to be, for example, either “non-defective (GO)” or “defective (NO-GO).” For example, if any dent, scratch, galling, or stain is recognized on the appearance of the target T1 as a result of the image inspection, then the target T1 may be determined (recognized) to be defective.

In the following description, the result of the decision (recognition) of the appearance is supposed to be either non-defective or defective unless otherwise stated. Nevertheless, the decision results do not have to be binary ones (i.e., either non-defective or defective). For example, the decision results may further include a “gray area” corresponding to an intermediate area between non-defective and defective. In that case, “gray area” and “defective” may be combined into a single category “gray/defective” and the decision result may be either “non-defective” or “gray/defective.” Furthermore, the category of the decision result does not have to be the “non-defective or defective” category, but may also be, for example, a “painted or non-painted” category or a “stained or stainless” category. In summary, the second category does not have to be a category indicating that the target T1 is “defective” as long as the second category is defined for the target T1 of the image inspection to be extracted (i.e., removed) by distinguishing the target T1 classified into the second category from the target T1 classified into the first category.

In this embodiment, the criterion information D1 output by the output processor 11 includes information about a decision boundary to be defined based on identification results obtained by a plurality of identification algorithms A0 (refer to FIGS. 1 and 2) which are different from each other. That is to say, the decision boundary is used as a criterion for determining, by an inspection algorithm, whether the target T1 should be classified into the first category or the second category.

As used herein, the expression “identification algorithms are different from each other” means that the identification algorithms have mutually different degrees of accuracy.

For example, one identification algorithm A0 belonging to the plurality of identification algorithms A0 may include a learned model generated by deep learning using a neural network (or a multilayer neural network). Examples of the neural networks may include a convolutional neural network (CNN) and a Bayesian neural network (BNN). The learned model may be implemented by, for example, installing a learned neural network into an integrated circuit such as an application specific integrated circuit (ASIC) or a field-programmable gate array (FPGA). Note that the learned model does not have to be a model generated by deep learning. Another identification algorithm A0 belonging to the plurality of identification algorithms A0 may include a learned model which has been machine-learned by making a human being enter and specify feature quantities without using any neural network, unlike the deep learning.

If the “identification algorithms are different from each other,” the plurality of learned models included in the plurality of identification algorithms A0 may all have been generated by deep learning using a neural network. Alternatively, the plurality of learned models included in the plurality of identification algorithms A0 may all have been generated by machine learning using no neural networks. For example, one identification algorithm A0 belonging to the plurality of identification algorithms A0 may include a learned model which has been generated by machine learning specialized on a whole defect such as a major scratch or dent. On the other hand, another identification algorithm A0 may include a learned model which has been generated by machine learning specialized on a local defect such as a minor scratch or dent. In addition, the expression “the identification algorithms are different from each other” may also mean that at least one parameter selected from the group consisting of the number of intermediate node layers in the learned model through which the input data passes, the number of nodes in each of those layers, and the connection structure between the nodes is different between the plurality of identification algorithms A0. Furthermore, the expression “the identification algorithms are different from each other” may also mean that the number of the data that has been machine learned so far is different between the plurality of identification algorithms.

In this embodiment, the first category may be, for example, a category indicating that the appearance of the target T1 is non-defective, and the second category is a category indicating that the appearance of the target T1 is defective.

On receiving a plurality of image data sets DS1 (refer to FIG. 1) about the target T1, each of the plurality of identification algorithms A0 identifies the category of each of the plurality of image data sets DS1. To each of the plurality of image data sets DS1, a label indicating either the first category or the second category is attached.

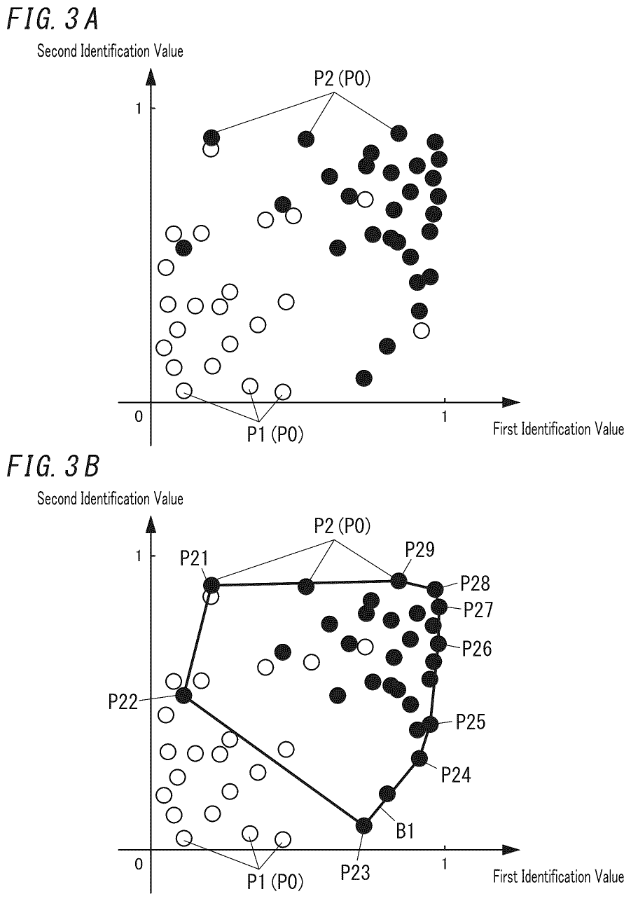

In this embodiment, the decision boundary is a convex hull boundary B1 (refer to FIG. 3B) to be defined based on a set of identification results about an image data set DS1, to which a label indicating the second category (e.g., defective) is attached, out of the plurality of image data sets DS1. To make the convex hull boundary B1 more easily understandable, the following description will be focused on two identification algorithms A0 using a graph on which a plurality of identification results output by these two identification algorithms A0 are plotted on a biaxial coordinate system (i.e., two-dimensional coordinate system) with X and Y axes. Note that if the number of the plurality of identification algorithms A0 is three, then the coordinate system on which the identification results are plotted may be a triaxial coordinate system, of which the number of axes is as many as the number of the identification algorithms A0. Considering the computational performance, load, and other parameters of the processing system 1 and the inspection system 2, the number of the plurality of identification algorithms A0 is supposed to be at most six, for example, and the coordinate system on which the identification results are plotted may also be at most a hexaxial coordinate system (six-dimensional system).

As used herein, the “convex hull” refers to the smallest convex set that contains a given set. The convex set includes at least one line segment which connects together an arbitrary pair of points belonging to the given set. The convex hull boundary B1 corresponds to either at least one side of a convex polygon or at least one face of a convex polyhedron, of which the vertices are defined by the outermost set of data points P2 which defines the boundary of the smallest convex set. The outermost set of data points P2 belongs to a set of data points P2 (i.e., a group of data points: refer to FIG. 3B) corresponding to the identification results with respect to an image data set DS1 of the second category. That is to say, in this embodiment, attention is paid to two identification algorithms A0, and therefore, the convex hull boundary B1 corresponds to sides of a two-dimensional convex polygon. Alternatively, if the number of the identification algorithms A0 is equal to or greater than three, then the convex hull boundary B1 may correspond to faces of a three- or more-dimensional convex polyhedron.

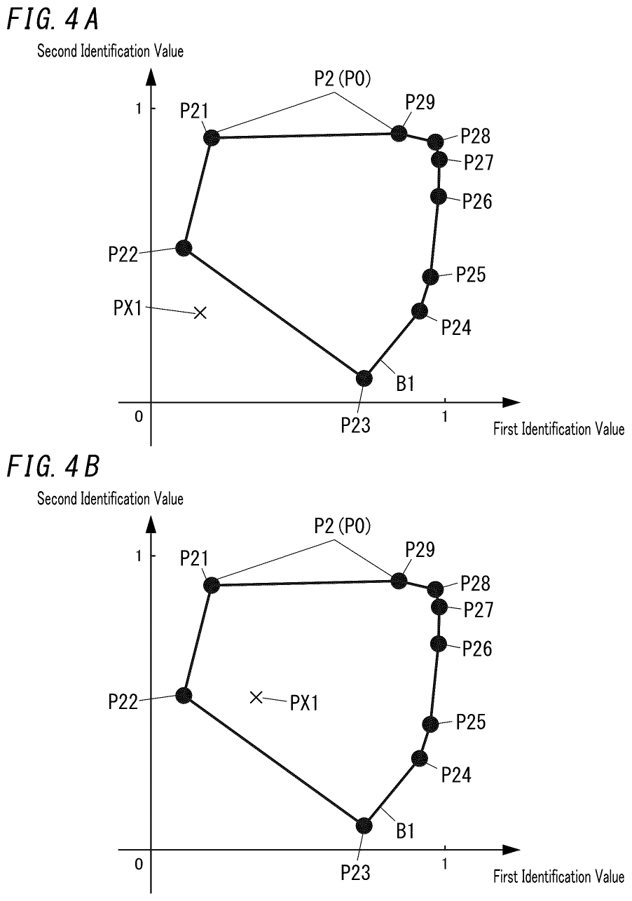

The inspection system 2 decides, if a data point PX1 corresponding to the identification results obtained by a plurality of identification algorithms A0 with respect to the image data IM1 of the target T1 shot in the inspection step is located inside the convex hull boundary B1 (refer to FIG. 4B), that the target T1 should be classified into the second category. On the other hand, the inspection system 2 decides, if the data point PX1 is located outside the convex hull boundary B1 (refer to FIG. 4A), that the target T1 should be classified into the first category.

In short, the processing system 1 has the function of outputting the criterion information D1 including information about the convex hull boundary B1 to be defined based on the identification results obtained by the plurality of identification algorithms A0. The inspection system 2 has the function of finally determining (deciding), based on the plurality of identification algorithms A0 and the convex hull boundary B1 of the criterion information D1, at the time of an actual image inspection, whether the target T1 should be classified into the first category or the second category.

In the following description, the processing system 1 is supposed to have the function of automatically defining the convex hull boundary B1 based on the identification results obtained by the identification algorithms A0. However, the processing system 1 does not have to have such a function of automatically defining the convex hull boundary B1. Alternatively, for example, the processing system 1 may have the identification results obtained by the identification algorithms A0 presented on a display device 17 (refer to FIG. 1), accept the entry of information about the convex hull boundary B1 that has been defined by the user, and then output criterion information D1 including information about the convex hull boundary B1.

According to this configuration, the processing system 1 includes the output processor 11 which outputs the criterion information D1 including information about a decision boundary that is the convex hull boundary B1. This reduces, compared to a situation where a decision is made that the target T1 should be classified into the second category just because a plurality of identification results includes at least one identification result indicating that the target T1 is highly likely to be classified into the second category, the chances of the target T1 that should actually be classified into the first category being classified, by mistake, into the second category at the time of image inspection. Consequently, the processing system 1 achieves the advantage of reducing the overdetection rate.

Also, a processing method according to this embodiment includes an output processing step including outputting the criterion information D1 applicable to the above-described inspection algorithm. The criterion information D1 includes information about a decision boundary to be defined based on the identification results obtained by a plurality of identification algorithms A0 that are different from each other. The decision boundary is used as a criterion for determining, by the inspection algorithm, whether the category of the target T1 is a first category or a second category. Each of the plurality of identification algorithms A0 identifies, in response to entry of a plurality of image data sets DS1, each representing the target T1, the category with respect to each of the plurality of image data sets DS1. A label indicating either the first category or the second category is attached to each of the plurality of image data sets DS1. The decision boundary is a convex hull boundary B1 to be defined based on a set of the identification results about an image data set DS1, to which the label indicating the second category is attached, out of the plurality of image data sets DS1. This provides a processing method contributing to reducing the overdetection rate. This processing method is used on a computer system (processing system 1). That is to say, this processing method may also be implemented as a program. A program according to this embodiment is designed to cause one or more processors to perform the processing method according to this embodiment.

### (2) Details

Next, a processing system 1 and inspection system 2 according to this embodiment and their peripheral devices (including an image capturing unit 3) will be described in detail with reference to FIGS. 1-9. Optionally, at least some of the peripheral devices may be included in the configuration of either the processing system 1 or the inspection system 2.

### (2.1) Overall Configuration

The processing system 1 is configured to generate criterion information D1, including a criterion (decision boundary) applicable to an inspection algorithm for the inspection system 2, and output the criterion information D1 to the inspection system 2. The inspection system 2 performs the inspection algorithm, to which the criterion included in the criterion information D1 is applied, to inspect the target T1 and thereby identify the category of the target T1 based on image data IM1 of the target T1 which is a product (or a semi-finished product). As described above, in this embodiment, the “category” is a category indicating whether the appearance of the target T1 is defective or non-defective. The category includes a first category indicating that the appearance of the target T1 is non-defective and a second category indicating that the appearance of the target T1 is defective.

In the following description, a person who performs the operation of preparing and creating the criterion information D1 using the processing system 1 will be hereinafter sometimes simply referred to as an “operator.” Also, the flow of the process of preparing and creating the criterion information D1 by using the processing system 1 will be hereinafter sometimes referred to as a “learning flow.”

Also, in the following description, a person who performs image inspection of the target T1 using the inspection system 2 will be hereinafter sometimes simply referred to as an “inspector.” Also, the flow of the process of making image inspection using the inspection system 2 will be hereinafter sometimes referred to as an “inspection flow.”

The operator and the inspector may be either the same person or two different persons, whichever is appropriate. If there is no need to distinguish the operator from the inspector, each of them will be hereinafter sometimes simply referred to as a “user” for the sake of convenience of description.

As shown in FIG. 1, the processing system 1 includes a processing unit 10, an input device 16, and a display device 17. The main functions of the processing system 1 (e.g., the functions of the processing unit 10) may be, for example, installed into either a desktop computer or a server installed within the premise of a factory where the processing steps including manufacturing and inspecting the target T1 are performed. The “server” as used herein is supposed to consist of a single server device. That is to say, the main functions of the processing system 1 may be provided for a single server device. However, this is only an example and should not be construed as limiting. Alternatively, the “server” may also be made up of a plurality of server devices. Specifically, the functions of the processing unit 10 may be distributed in a plurality of server devices. Still alternatively, such server devices may also be installed as a cloud of servers outside the premise of the factory to form a cloud computing system. Yet alternatively, some functions of the processing system 1 may also be distributed in not only servers or desktop computers but also laptop computers, tablet computers, or smartphones as well to name just a few. In any case, if the plurality of functions of the processing system 1 are distributed in a plurality of devices, each of the plurality of devices is preferably connected to the other devices to be ready to communicate with the other devices.

As shown in FIG. 2, the inspection system 2 includes a processing unit 20, a storage device 24, and an inspection result notifier 25. The main functions of the inspection system 2 (e.g., the functions of the processing unit 20) may be, for example, installed into either a desktop computer or a server installed within the premise of a factory where the processing steps including manufacturing and inspecting the target T1 are performed. The main functions of the inspection system 2 may be provided for a single server device or distributed in a plurality of server devices, whichever is appropriate. Still alternatively, such server devices may also be installed as a cloud of servers outside the premise of the factory to form a cloud computing system. Yet alternatively, some functions of the inspection system 2 may also be distributed in not only servers or desktop computers but also laptop computers, tablet computers, or smartphones as well to name just a few. In any case, if the plurality of functions of the inspection system 2 are distributed in a plurality of devices, each of the plurality of devices is preferably connected to the other devices to be ready to communicate with the other devices.

The inspection system 2 is ready to establish either a wireless communication or a wired communication with the image capturing unit 3 as a peripheral device. Optionally, the processing system 1 may also be ready to communicate with the image capturing unit 3.

The processing system 1 is ready to establish either a wireless communication or a wired communication with the inspection system 2. In particular, the main functions of the processing system 1 and the inspection system 2 (such as the functions of the processing unit 10 and the processing unit 20) may be installed into the same device (such as a desktop computer or a server) such that information is transmitted and received within the same device. The processing system 1 communicates with the inspection system 2 and transmits the criterion information D1 generated by the processing system 1 to the inspection system 2. Note that the processing system 1 does not have to be ready to communicate with the inspection system 2. Alternatively, the main functions of the processing system 1 and the main functions of the inspection system 2 may be installed into two different devices, respectively.

For example, the criterion information D1 generated by the processing system 1 may be once output to an electrically programmable nonvolatile semiconductor memory such as a USB flash memory and then loaded into the inspection system 2 via the semiconductor memory. Alternatively, the criterion information D1 generated by the processing system 1 may be transmitted to an external server device via a wide area network such as the Internet and then loaded into the inspection system 2 via the external server device.

The processing system 1 and the inspection system 2 will be described in further detail later.

The image capturing unit 3 (image capturing system) is a system for generating, as the image data IM1 (inspection image) of the target T1, an image (digital image) representing the appearance of the target T1 during the inspection flow. The image capturing unit 3 generates image data IM1 representing a surface of the target T1 by capturing the surface, lighted up by a lighting fixture, for example, of the target T1. The image capturing unit 3 includes one or more RGB cameras, for example. Each camera includes one or more image sensors. Alternatively, each camera may include one or more line sensors. The image capturing unit 3 is connected to a network and ready to communicate with the inspection system 2 via the network. The image data IM1 generated is transmitted to the inspection system 2. The network may be any type of network without limitation. For example, the network may be established by either a wired communication through a communications line or a wireless communication, whichever is appropriate.

The image capturing unit 3 captures images of targets T1, which are sequentially transported one after another by a carrier such as a conveyor, and transmits their image data IM1 (inspection images) to the inspection system 2 during the inspection flow. The inspection system 2 identifies the category of each target T1 (i.e., determines whether the target T1 is defective or non-defective) and transmits the decision result to a terminal device used by the inspector. Examples of the terminal device used by the inspector include a dedicated surveillance monitor, a desktop computer, a laptop computer, a tablet computer, and a smartphone. If the decision result indicates that the target T1 is defective, then the inspection system 2 sends an alert message to the inspector's terminal device. In addition, the inspection system 2 also transmits a signal to management equipment for managing the production line to perform predetermined processing (such as discarding the target T1, temporarily stopping running the carrier, or transferring the target T1 to a storage place where the target T1 is to be checked visually) on the target T1 which has turned out to be a defective product.

### (2.2) Processing System

The processing system 1 includes the processing unit 10, the input device 16, and the display device 17 as described above (refer to FIG. 1). The processing system 1 further includes a programmable nonvolatile memory (storage device) such as an electrically erasable programmable read-only memory (EEPROM) for storing various types of information.

The display device 17 may be implemented as either a liquid crystal display or an organic electroluminescent (EL) display, for example. The display device 17 may be a touchscreen panel display. The display device 17 may be provided, for example, as a part of a communications device used by the operator (or user) such as a desktop computer, a laptop computer, a tablet computer, or a smartphone. The display device 17 displays a “particular image data set DS1” provided by a display processor 14 of the processing unit 10 (to be described later). The display device 17 may display not only the particular image data set DS1 but also various other types of information as well.

The input device 16 includes at least one user interface such as a mouse, a keyboard, or a pointing device. The input device 16 may be provided, for example, for the communications device used by the operator such as a desktop computer, a laptop computer, a tablet computer, or a smartphone. If the display device 17 is a touchscreen panel display, then the display device 17 may also perform the function of the input device 16.

The input device 16 accepts the entry of relabeling with respect to the label that has been attached to the image data set DS1 displayed. The operator visually checks the particular image data set DS1 displayed on the display device 17 and specifies, when finding the label attached to the image data set DS1 wrong, a correct label, for example, by operating the input device 16.

The processing unit 10 may be implemented as a computer system including one or more processors (microprocessors) and one or more memories. The functions of the processing unit 10 are performed by making the one or more processors execute one or more programs (applications) stored in the one or more memories. In this embodiment, the program is stored in advance in the memory of the processing unit 10. Alternatively, the program may also be downloaded via a telecommunications line such as the Internet or distributed after having been stored in a non-transitory storage medium such as a memory card.

As shown in FIG. 1, the processing unit 10 includes an algorithm processor 12, a boundary definer 13, a criterion adjuster 15, a display processor 14, and the output processor 11. That is to say, the processing unit 10 performs the respective functions of the algorithm processor 12, the boundary definer 13, the criterion adjuster 15, the display processor 14, and the output processor 11.

The algorithm processor 12 enters a plurality of image data sets DS1 into a plurality of identification algorithms A0 and outputs the identification results obtained by the plurality of identification algorithms A0. Each of the plurality of identification algorithms A0 identifies, in response to the entry of the plurality of image data sets DS1, the category of each of the plurality of image data sets DS1.

Next, the image data sets DS1 and the identification algorithms A0 will be described in detail.

The image data sets DS1 are labeled image data sets about the target T1, which are needed to define a criterion during the learning flow, and are preferably prepared in huge numbers (e.g., on the order of a few hundreds to several thousands). To prepare the image data sets DS1, the operator collects multiple types of image data of the target T1 and performs operations such as labeling in advance.

The algorithm processor 12 may acquire, during the learning flow, the image data sets DS1 from, for example, an external storage device (which may be an external cloud server, for example) that stores the image data sets DS1. Alternatively, the image data sets DS1 may also be stored in advance in the storage device of the processing system 1. A label indicating either the first category (non-defective) or the second category (defective) is attached to each of the plurality of image data sets DS1. The plurality of image data sets DS1 are respectively entered into multiple different identification algorithms A0 during the learning flow. The following description will be focused on only two identification algorithms A0 (hereinafter referred to as a “first identification algorithm A1” and a “second identification algorithm A2,” respectively) out of the multiple different identification algorithms A0 to make the following description easily understandable. Specifically, the first identification algorithm A1 may include, for example, a learned model generated by deep learning and preprocessing (such as image processing) of converting the image data into the form that makes the image data applicable as input data for the learned model. The second identification algorithm A2 may include, for example, a learned model which has been generated by machine-learning feature quantities in accordance with a human being's entry or designation and preprocessing (such as image processing) of converting the image data into the form that makes the image data applicable as input data for the learned model.

The plurality of image data sets DS1 may include a data set in which a label indicating “defective” or “non-defective” is attached to the image data of the target T1 which has been generated by using the same image capturing unit 3 as the image data IM1 (inspection image) during the inspection flow. In addition, the plurality of image data sets DS1 may also include a data set in which a label indicating “defective” or “non-defective” is attached to the image data of the target T1 which has been generated by using a different image capturing unit from the image capturing unit 3. The plurality of image data sets DS1 may further include a data set in which the image data IM1 (inspection images) that were captured in the past during the inspections performed at multiple sites (e.g., factories) by the image capturing units 3 installed at those sites have been collected and in which a label indicating either “defective” or “non-defective” is attached to each of these image data IM1. The image data of the plurality of image data sets DS1 may further include processed data generated by subjecting the image of the target T1 to image processing.

Optionally, the plurality of image data sets DS1 may include learning data which has been used to generate a plurality of learned models included in the plurality of identification algorithms A0. As used herein, the “learning data” refers to learning data for use to make machine learning about a model.

Each of these “learned models” included in each of the plurality of identification algorithms A0 is a program which estimates, in response to entry of input data about an identification target (i.e., the appearance of the target T1), what condition the identification target assumes and outputs the result of estimation (i.e., identification result). As used herein, the “learned model” refers to a model about which machine learning using the learning data has been done. Also, the “learning data (set)” as used herein refers to a data set including, in combination, input data (image data) entered into a model and a label attached to the input data, i.e., refers to so-called “training data.” That is to say, each of the plurality of learned models included in the plurality of identification algorithms A0 is a model about which machine learning has been done as supervised learning.

The plurality of identification algorithms A0 are used in both the learning flow and the inspection flow. Nevertheless, the input data entered into the plurality of identification algorithms A0 during the learning flow is different from the input data entered into the plurality of identification algorithms A0 during the inspection flow. Specifically, in the learning flow, the plurality of image data sets DS1 are the input data. On the other hand, in the inspection flow, the image data IM1 (inspection image) is the input data.

The algorithm processor 12 acquires, during the learning flow, the plurality of identification algorithms A0 from either the storage device 24 (to be described later) of the inspection system 2 or an external storage device (which may also be an external cloud server). Alternatively, the plurality of identification algorithms A0 may be stored in advance in a storage device of the processing system 1.

The plurality of identification algorithms A0 outputs, with respect to each of the plurality of image data sets DS1, an identification value as a numerical value indicating the probability that the target T1 is classified into either the first category or the second category, as the identification result. In this embodiment, each identification algorithm A0 may output, in response to the entry of the image data set DS1, an identification value (degree of reliability) indicating the probability that the target T1 is classified into the second category (defective), for example. In this case, the higher the identification value is, the more likely the target T1 is to be classified into the second category (defective). This increases the chances of outputting the identification results obtained by the plurality of identification algorithm A0 in a highly reliable form.

The boundary definer 13 defines the convex hull boundary B1 based on the identification result (identification value) obtained with respect to the image data set DS1, to which the label indicating the second category is attached, out of the plurality of image data sets DS1. As used herein, the “convex hull boundary B1” according to this embodiment refers to a decision boundary to be defined based on the identification results obtained by the plurality of identification algorithms A0. The decision boundary is used as a criterion for determining, by an inspection algorithm of the inspection system 2, whether the category of the target T1 is the first category or the second category. That is to say, the criterion information D1 output by the processing system 1 includes information about the decision boundary (convex hull boundary B1).

The identification values output by the plurality of identification algorithms A0, respectively, are preferably either values falling within a predetermined range or scaled by the boundary definer 13 to fall within the predetermined range. In this embodiment, the boundary definer 13 may scale the identification values (degrees of reliability) output by the respective identification algorithms A0 to numerical values falling within a predetermined range from 0.00 to 1.00, for example. In the following description, the scaled identification values will also be hereinafter simply referred to as “identification values.” In this embodiment, the closer to 1.00 the identification value is, the more likely the category of the target T1 is supposed to be identified by the identification algorithm A0 to be the second category (defective). However, this is only an example and should not be construed as limiting. Alternatively, the closer to 1.00 the identification value is, the more likely the category of the target T1 may be identified by the identification algorithm A0 to be the first category (non-defective).

Scaling the identification values in this manner reduces the chances of increasing the dispersion (bias) in identification value among the respective identification algorithms A0, thus making it easier for the processing system 1 to automatically determine the convex hull boundary B1. In this case, generally speaking, the identification value obtained by the identification algorithm A0 is not necessarily proportional to the chances of the target T1 being classified into the second category (defective). Thus, a technique such as temperature scaling for calibrating the identification value to make the identification value proportional to the chances may be applied. Making the calibration allows, if the identification value obtained by the first identification algorithm A1 is 0.8 and the identification value obtained by the second identification algorithm A2 is 0.8, the degrees of reliability of these identification values to be calibrated such that these identification values of 0.8 indicate approximately the same degree of defectiveness.

In the following description, the identification value obtained by the first identification algorithm A1 will be hereinafter referred to as a “first identification value” and the identification value obtained by the second identification algorithm A2 will be hereinafter referred to as a “second identification value.”

Next, reference will be made to FIGS. 3A and 3B, which illustrate a set of data points, to make the concept of the “convex hull boundary B1” more easily understandable.

The boundary definer 13 plots out, on a coordinate system with multiple axes, identification values output by the plurality of identification algorithms A0 with respect to each of the plurality of image data sets DS1. FIG. 3A illustrates an exemplary set of data points P0 plotted by the boundary definer 13 in response to the entry of respective image data sets DS1 with a first identification value obtained by the first identification algorithm A1 plotted as an X-axis value (abscissa) and with a second identification value obtained by the second identification algorithm A2 plotted as a Y-axis value (ordinate). Note that in not only FIG. 3A but also each of FIGS. 3B-7B, the first identification value obtained by the first identification algorithm A1 is also plotted as an X-axis value and a second identification value obtained by the second identification algorithm A2 is also plotted as a Y-axis value.

In each of the data points P0 shown in FIG. 3A, an X-axis value and a Y-axis value thereof respectively correspond to a first identification value and a second identification value of a corresponding image data set DS1. For example, if a first identification value of an image data set DS1 is 0.60 and a second identification value thereof is 0.10, then a data point P0 corresponding to the image data set DS1 is located at coordinates (X, Y)=(0.60, 0.10).

The open circle data points P1 indicate the first identification values and second identification values for image data sets DS1 to which a label indicating the first category (non-defective) is attached. On the other hand, the solid circle data points P2 indicate the first identification values and second identification values for image data sets DS1 to which a label indicating the second category (defective) is attached.

A data point P0, of which the coordinates (X, Y) are close to (1, 1), indicates that the target T1 is highly likely to be defective according to both the first identification algorithm A1 and the second identification algorithm A2. Actually, in the example shown in FIGS. 3A and 3B, most of the data points P0, of which the coordinates (X, Y) are close to (1, 1), correspond to image data sets DS1, to which a label indicating the second category (defective) is attached. That is to say, it can be said that the identification results each agree with the solution of the label.

Conversely, a data point P0, of which the coordinates (X, Y) are close to the origin (0, 0), indicates that the target T1 is highly likely to be non-defective according to both the first identification algorithm A1 and the second identification algorithm A2. Actually, in the example shown in FIGS. 3A and 3B, most of the data points P0, of which the coordinates (X, Y) are close to (0, 0), correspond to image data sets DS1, to which a label indicating the first category (non-defective) is attached. That is to say, it can be said that the identification results each agree with the solution of the label.

However, there is some data points P0, of which the identification values are close to zero, with respect to image data sets DS1, to which the label indicating the second category (defective) is attached.

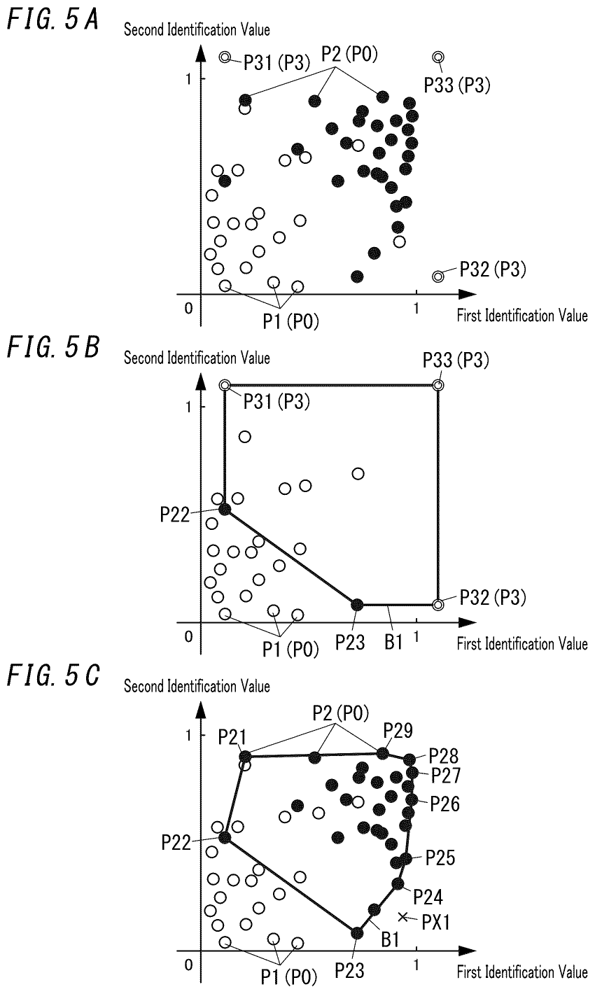

The boundary definer 13 defines the convex hull boundary B1 to be a boundary serving as a convex set, of which the vertices are defined by data points P2 belonging to a set of data points P2 having a label indicating the second category attached, out of a plurality of data points P0 corresponding to a plurality of image data sets DS1. In the example shown in FIG. 3B, the boundary definer 13 defines the convex hull boundary B1 to be a boundary serving as a convex set, of which the vertices are defined by nine data points P2 (P21-P29) in total belonging to a set of data points P2 having the label indicating the second category (defective) attached. It can be easily understood that the convex hull boundary B1, forming a convex polygon, of which the vertices are defined by the data points P21-P29, defines the boundary of the smallest convex set. In the set of data points P2 to which the label indicating the second category (defective) is attached, every line segment connecting together an arbitrary pair of data points P2 is included within the convex hull boundary B1. In this embodiment, such a boundary serving as a convex set, of which the vertices are defined by the data points P21-P29, is defined as the convex hull boundary B1, thus making it easier to automatically define the convex hull boundary B1. Note that the vertices of the convex hull boundary B1 may also include an auxiliary set of data points P3 to be described later (refer to FIGS. 5A and 5B). That is why the number of the data points P2 defined by the vertices of the convex hull boundary B1 may also be only one.

The boundary definer 13 formulates the respective vertices and sides that form the convex hull boundary B1 as a mathematical equation to allow the output processor 11 to output the convex hull boundary B1 to an external device. Thus, the criterion information D1 includes, for example, information about equations for uniquely defining the convex hull boundary B1. Specifically, the boundary definer 13 obtains an equation for uniquely defining the coordinates of the respective vertices of the convex hull boundary B1 (i.e., the respective locations of the data points P21-P29) and the gradients of respective sides that connect together pairs of adjacent vertices. In the example shown in FIG. 3B, the convex hull boundary B1 is a two-dimensional convex polygon. If the convex hull boundary B1 is a three- or more dimensional convex polyhedron, the boundary definer 13 may obtain an equation for uniquely defining at least one face of the convex hull boundary B1. In other words, the criterion information D1 includes information about at least one of the vertices, sides, or faces that form the convex hull boundary B1.

As will be described in detail later, the inspection flow includes determining, depending on whether a data point PX1 corresponding to a first identification value and a second identification value with respect to an inspection image is located inside or outside the convex hull boundary B1 thus defined, whether the target T1 should be classified into the first category (non-defective) or the second category (defective).

In the inspection flow, even though the identification result obtained by one identification algorithm A0 with respect to an inspection image indicates that the target T1 is highly likely to be classified into the second category (recognized as a defective product), the identification result obtained by another identification algorithm A0 with respect to the same inspection image may indicate that the target T1 is highly likely to be classified into the first category (recognized as a non-defective product). Specifically, the data point PX1 shown in FIG. 5C has a first identification value close to 1.0 but an extremely low second identification value. Image data represented by such a data point PX1 has a low frequency of occurrence. That is why the set of data points P2 of the second category (defective) used to define the convex hull boundary B1 may include an insufficient number of data points P2 present in the area surrounding the data point PX1. That is to say, chances are the convex hull boundary B1 may fail to be defined appropriately due to the low frequency of occurrence of such image data. Consequently, in that case, the target T1 that should be identified to be defective may be identified to be non-defective, thus producing so-called “over-learning.” In other words, using the convex hull boundary B1 shown in FIG. 3B as it is causes the data point PX1 shown in FIG. 5C to be classified into the first category (non-defective) to miss a defective product because the data point PX1 is located outside the convex hull boundary B1. Thus, the boundary definer 13 according to this embodiment defines the convex hull boundary B1 using not only the set of data points 2P, to which the label indicating the second category (defective) is attached, but also additional dummy data points P3 (auxiliary set of data points P3: refer to FIGS. 5A and 5B) as well.

That is to say, the boundary definer 13 plots out, on a coordinate system with multiple axes, coordinate values including values equal to or greater than an upper limit value of a predetermined range, to be the auxiliary set of data points P3. The boundary definer 13 defines the convex hull boundary B1 with the auxiliary set of data points P3 included in the set of data points P2 to which the label indicating the second category is attached. As described above, the identification values output by the respective identification algorithms A0 may be scaled to numerical values falling within the range from 0 to 1, for example. That is to say, as for an identification value output by any identification algorithm A0, its minimum value that can be output is zero and its maximum value that can be output is one. That is why in this embodiment, the identification values obtained by any identification algorithm A0 have the same predetermined numerical value range from 0 to 1 and the value equal to or greater than the upper limit value is a value equal to or greater than 1 (i.e., a value which is equal to or greater than 1.0 and which includes a value of 1.0). Optionally, the scaling range may vary from one identification algorithm A0 to another. For example, the first identification value may be scaled to a numerical value falling with the range from 0 to 1 and the second identification may be scaled to a numerical value falling within the range from 0 to 2.

The number of the auxiliary data points P3 is not limited to any particular value. In the example shown in FIGS. 5A and 5B, three auxiliary data points P3 (P31-P33) are plotted.

The coordinates (X, Y) of the auxiliary data point P31 are (X₁, 1.1). X₁ of the auxiliary data point P31 is the minimum first identification value in the set of data points P2 to which the label indicating the second category is attached. In the example shown in FIGS. 5A and 5B, the first identification value “0.1” of the data point P22 is the minimum first identification value in the set of data points P2. That is why the X-axis coordinate value X₁ of the auxiliary data point P31 is set at 0.1. On the other hand, a value equal to or greater than the maximum value “1” of the second identification value (i.e., a value equal to or greater than the upper limit value of the predetermined range; e.g., 1.1) is set as the Y-axis coordinate value of the auxiliary data point P31. The value equal to or greater than the upper limit value of the predetermined range may be a value equal to or greater than 1 (i.e., a value equal to or greater than 1.0) and does not have to be 1.1 but may also be 1.0 or 2.0, for example.

The coordinates (X, Y) of the auxiliary data point P32 are (1.1, Y₁). Y₁ of the auxiliary data point P32 is the minimum second identification value in the set of data points P2, to which the label indicating the second category is attached. In the example shown in FIGS. 5A and 5B, the second identification value “0.1” of the data point P23 is the minimum second identification value in the set of data points P2. That is why the Y-axis coordinate value Y₁ of the auxiliary data point P32 is set at 0.1. On the other hand, a value equal to or greater than the maximum value “1” of the first identification value (i.e., a value equal to or greater than the upper limit value of the predetermined range; e.g., 1.1) is set as the X-axis coordinate value of the auxiliary data point P32.

The coordinates (X, Y) of the auxiliary data point P33 are (1.1, 1.1). That is to say, a value “1.1” equal to or greater than the maximum value “1” of the first identification value (i.e., a value equal to or greater than the upper limit value of the predetermined range) is set as the X-axis coordinate value of the auxiliary data point P33. In addition, a value “1.1” equal to or greater than the maximum value “1” of the second identification value (i.e., a value equal to or greater than the upper limit value of the predetermined range) is set as the Y-axis coordinate value of the auxiliary data point P33.

That is to say, the auxiliary set of data points P3 is a set of data points in which coordinate values on the coordinate system with the multiple axes are a combination of a minimum value of the identification values output by the plurality of identification algorithms A0, respectively, with respect to the set of data points P2, to which the label indicating the second category is attached, and a value equal to or greater than the upper limit value of the predetermined range. Note that in the three-dimensional coordinate system (i.e., if the number of the identification algorithms A0 is three), for example, the number of the auxiliary data points P3 may be seven.

The boundary definer 13 defines the convex hull boundary B1 with the auxiliary set of data points P31-P33 included in the set of data points P2. As a result, a convex hull boundary B1 is defined as a convex polygon including, as its vertices, all of the auxiliary set of data points P31-P33 as shown in FIG. 5B.

Plotting the auxiliary set of data points P3 in this manner increases the chances of a data point PX1 such as the one shown in FIG. 5C falling within the convex hull boundary B1, thereby increasing the chances of an inspection image of the data point PX1 being classified into the second category (defective). Consequently, this reduces the chances of making an erroneous decision (i.e., missing a defective product) due to overlearning.

In addition, as can be seen easily by comparing the convex hull boundary B1 shown in FIG. 5B with the convex hull boundary B1 shown in FIG. 5C, the convex hull boundary B1 defined by plotting the auxiliary set of data points P3 is a convex polygon with a decreased number of vertices (or a decreased number of faces in the case of a convex polyhedron). Decreasing the number of vertices of a convex polygon or the number of faces of a convex polyhedron means decreasing the amount of information of an equation, for example, for uniquely defining the convex hull boundary B1. That is to say, this simplifies the inspection algorithm, thus making it easier to shorten the time it takes to make the decision by the inspection algorithm.

In particular, a lot of data points P0 are highly likely to be plotted out around the coordinates (1, 1). If a lot of data points P0 are plotted around the coordinates (1, 1), then either vertices or faces may be densely packed around the coordinates (1, 1). Plotting out the auxiliary set of data points P3 may reduce the chances of the vertices or faces of the convex hull boundary B1 being densely packed around the coordinates (1, 1).

According to the present disclosure, the convex hull boundary B1 does not have to be defined with the auxiliary set of data points P3 plotted as well. Rather, a command is preferably acceptable via the input device 16 as to whether the auxiliary set of data points P3 needs to be plotted or not (i.e., whether the setting should be enabled or disabled). In addition, a command is also preferably acceptable via the input device 16 as to whether the value equal to or greater than the upper limit value should be changed and whether the locations or number of the auxiliary data points P3 should be changed. Information about these settings of the auxiliary set of data points P3 is stored in the storage device of the processing system 1.

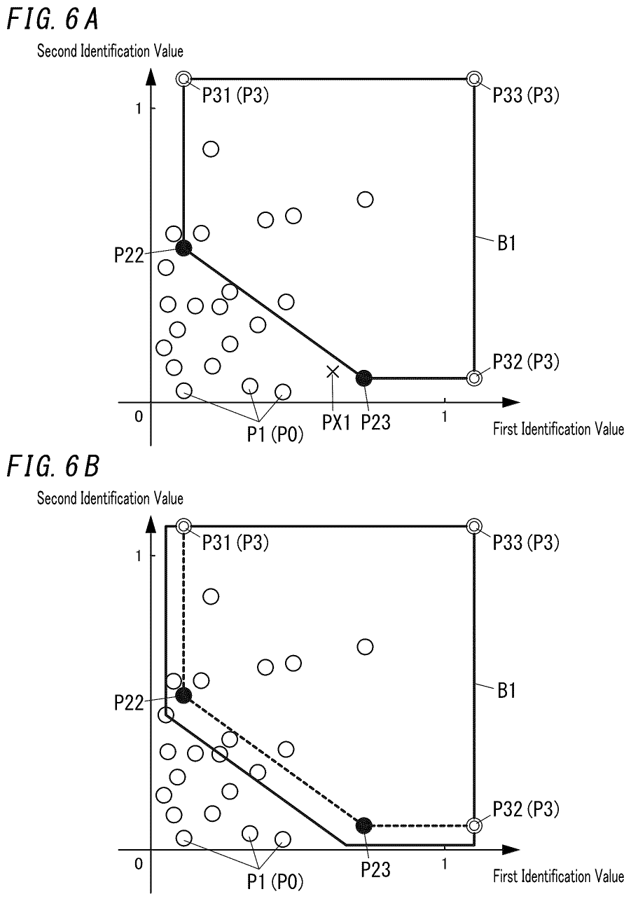

Also, unless a sufficient number of image data sets DS1, to which the label indicating the second category (defective) is attached, are prepared in advance, there may be an inspection image which causes an identification value slightly less than the convex hull boundary B1 to be output (refer to the data point PX1 shown in FIG. 6A). That is to say, in that case, an erroneous decision may be made (i.e., a defective product may be missed) due to the shortage of defective image data.

To overcome such a problem, according to this embodiment, the criterion adjuster 15 adjusts the criterion by making a predetermined margin adjustment to the convex hull boundary B1 to expand the area surrounded with the convex hull boundary B1. For example, the criterion adjuster 15 shifts at least a part of the convex hull boundary B1 to slightly expand the area surrounded with the convex hull boundary B1 as shown in FIG. 6B. That part to be shifted is preferably a part, adjacent to a set of data points with the label indicating the first category (non-defective) attached, of the convex hull boundary B1. In the example shown in FIG. 6B, the coordinate values of new vertices are calculated by multiplying the respective X-axis and Y-axis coordinate values (i.e., first identification values and second identification values) of the data points P22 and P23 by a predetermined factor less than 1.0 (e.g., 1-10⁻³). As a result, the side (line segment) connecting together these data points P22 and P23 shifts toward the origin. In addition, the X-axis coordinate value X₁ of the auxiliary data point P31 and the Y-axis coordinate value Y₁ of the auxiliary data point P32 are also multiplied by the predetermined factor. On the other hand, the auxiliary data point P33 is fixed at (1.1, 1.1) with its coordinate values not multiplied by the predetermined factor.

Making such a margin adjustment to the convex hull boundary B1 increases the chances of outputting more reliable criterion information D1. Consequently, this reduces the chances of missing a defective product.

According to the present disclosure, the margin adjustment does not have to be made to the convex hull boundary B1. Rather, a command is preferably acceptable via the input device 16 as to whether the margin adjustment needs to be made or not (i.e., whether the margin adjustment should be enabled or disabled). In addition, a command is also preferably acceptable via the input device 16 as to whether the predetermined factor, for example, should be changed. Information about the settings of the margin adjustment is stored in the storage device of the processing system 1.

The display processor 14 makes the display device 17 display a (particular) image data set DS1 belonging to the plurality of image data sets DS1. The particular image data set DS1 corresponds to the data points P2 (P21-P29) (representing the vertices of the convex hull boundary B1). For example, the display processor 14 makes the display device 17 display the image data of the particular image data set DS1 such that the label attached thereto is easily recognizable. In addition, the display processor 14 preferably also makes the display device 17 display a message prompting the operator to visually check the image data and a message prompting the operator to answer the question of whether the label attached to the image data to indicate the second category (defective) is correct or wrong.

That is to say, this embodiment allows the operator to visually check the image data set DS1 corresponding to the vertices of the convex hull boundary B1 on the display device 17. For example, the display processor 14 may make the display device 17 display a particular image data set DS1, to which the label indicating the second category is attached and which respectively correspond to the nine vertices (i.e., the data points P21-P29) of the convex hull boundary B1 shown in FIG. 3B. If the auxiliary set of data points P3 are plotted, then the display processor 14 may make the display device 17 display image data sets DS1, to which the label indicating the second category is attached and which respectively correspond to the two vertices (i.e., the data points P22, P23), other than the auxiliary set of data points P3, out of the five vertices of the convex hull boundary B1 shown in FIG. 5B.

The operator visually checks the image data displayed. When finding the label attached to indicate the second category (defective) correct, the operator answers, via the input device 16, that the label is correct. On the other hand, when finding the label attached to indicate the second category (defective) wrong, the operator answers, via the input device 16, that the label is wrong and makes a request for relabeling to change the label into the one indicating the first category (non-defective).

On receiving the request for relabeling from the operator via the input device 16, the processing system 1 changes the label of the particular image data set DS1 in question into the one indicating the first category (non-defective). After that, the boundary definer 13 defines the convex hull boundary B1 all over again. That is to say, the boundary definer 13 updates the convex hull boundary B1 based on the result of relabeling accepted by the input device 16.

As can be seen, the processing system 1 may make relabeling by having the display device 17 display the particular image data set DS1. This allows, when there is any wrong label, the user to correct the label efficiently. In addition, this also increases the degree of reliability of the convex hull boundary B1.

The output processor 11 outputs criterion information D1 including information about the convex hull boundary B1 defined by the boundary definer 13. In this embodiment, the output processor 11 outputs criterion information D1, including information about, for example, an equation for uniquely defining the convex hull boundary B1, to the inspection system 2. When receiving the request for relabeling, the output processor 11 outputs criterion information D1 including information about the updated convex hull boundary B1.

The output processor 11 may output the criterion information D1 at any timing without limitation. For example, the criterion information D1 may be output at an arbitrary timing when the operator requests the criterion information D1 via the input device 16.

For example, in some cases, a new type of defect may be found, which requires a new image data set DS1 to be added. Every time an image data set DS1 is added, the operator may request the criterion information D1. The processing system 1 outputs criterion information D1 including information about the latest convex hull boundary B1 with the new image data set DS1 taken into account. Thus, if the criterion information D1 has already been stored in the storage device 24 of the inspection system 2, then the criterion information D1 is updated into information about the latest convex hull boundary B1.

### (2.3) Inspection System

The inspection system 2 is configured to perform an inspection algorithm to which the criterion information D1 provided by the processing system 1 is applied. As shown in FIG. 2, the inspection system 2 includes the processing unit 20, the storage device 24, and the inspection result notifier 25.

The processing unit 20 may be implemented as a computer system including one or more processors (microprocessors) and one or more memories. The functions of the processing unit 20 are performed by making the one or more processors execute one or more programs (applications) stored in the one or more memories. In this embodiment, the program is stored in advance in the memory of the processing unit 20. Alternatively, the program may also be downloaded via a telecommunications line such as the Internet or distributed after having been stored in a non-transitory storage medium such as a memory card.

As shown in FIG. 2, the processing unit 20 includes an image acquirer 21, an identification result obtainer 22, and a decider 23. That is to say, the processing unit 20 performs the respective functions of the image acquirer 21, the identification result obtainer 22, and the decider 23.

The image acquirer 21 acquires the image data IM1 of the target T1. The image acquirer 21 acquires the image data IM1 (inspection image) from the image capturing unit 3 in real time as needed during the inspection flow.

The identification result obtainer 22 obtains identification results from the plurality of identification algorithms A0 by entering the image data IM1 acquired by the image acquirer 21 into the plurality of identification algorithms A0. That is to say, every time the identification result obtainer 22 obtains the image data IM1 from the image capturing unit 3 during the inspection flow, the identification result obtainer 22 enters the image data IM1 into the plurality of identification algorithms A0, thereby obtaining as many identification results with respect to each inspection image as the plurality of identification algorithms A0. As described above, the plurality of identification algorithms A0 for use in the inspection flow are the same as the plurality of identification algorithms A0 for use in the learning flow.

For example, the identification result obtainer 22 enters an inspection image acquired at a timing into each of the first identification algorithm A1 and the second identification algorithm A2. Then, the identification result obtainer 22 obtains a first identification value and a second identification value with respect to the inspection image from the first identification algorithm A1 and the second identification algorithm A2, respectively.

The identification result obtainer 22 uses the plurality of identification algorithms A0 stored in the storage device 24. Alternatively, the identification result obtainer 22 may obtains a plurality of identification algorithms A0 from an external storage device (which may also be an external cloud server).

The storage device 24 may be a programmable nonvolatile memory such as an EEPROM and stores in advance a program about the inspection algorithm. In addition, the storage device 24 also stores in advance the plurality of identification algorithms A0 (such as learned models). Furthermore, the storage device 24 may also store the criterion information D1 including information about, for example, an equation for uniquely defining the convex hull boundary B1 which has been provided by the processing system 1. Alternatively, the storage device 24 may be a memory of the processing unit 20.

The decider 23 makes a decision about the category based on a positional relationship between the identification results obtained by the identification result obtainer 22 and the convex hull boundary B1 of the criterion information D1. Specifically, if the positional relationship indicates that the identification result obtained by the identification result obtainer 22 falls within the convex hull boundary B1, then the decider 23 decides that the appearance of the target T1 is defective. On the other hand, if the positional relationship indicates that the identification result obtained by the identification result obtainer 22 falls outside of the convex hull boundary B1, then the decider 23 decides that the appearance of the target T1 is non-defective.

For example, the decider 23 locates, on the biaxial coordinate system, the position of a first identification value and a second identification value as a data point PX1 with respect to an inspection image acquired at a certain timing. Then, when finding the data point PX1 falling outside of the convex hull boundary B1 as shown in FIG. 4A, the decider 23 finally decides that the appearance of the target T1 is non-defective. On the other hand, when finding the data point PX1 falling within the convex hull boundary B1 as shown in FIG. 4B, the decider 23 finally decides that the appearance of the target T1 is defective. Even when the data point PX1 overlaps with the convex hull boundary B1, the decider 23 may also finally decide that the appearance of the target T1 is defective.

That is to say, the inspection system 2 finally determines, by using the convex hull boundary B1 as a criterion, whether the appearance of the target T1 is defective or non-defective, instead of finally determining, directly based on the identification results (identification values) obtained by the plurality of identification algorithms A0, whether the appearance of the target T1 is defective or non-defective.

Note that if the convex hull boundary B1 is a biaxial (i.e., two-dimensional) boundary, the decider 23 may determine, by relatively simple arithmetic logic, whether the data point PX1 falls within, or outside of, the convex hull boundary B1. However, if the convex hull boundary B1 is a three- or more dimensional boundary, then the arithmetic logic for determining whether the data point PX1 falls within, or outside of, the convex hull boundary B1 may be rather complicated.

Thus, in this embodiment, the decider 23 has a computational capability comparable to the capability of the boundary definer 13 of the processing system 1 as to calculating the convex hull boundary B1. Then, the decider 23 calculates the convex hull boundary B1 (hereinafter referred to as a “provisional boundary” so as not to be mixed up with the convex hull boundary B1 serving as an original criterion) all over again with the data point PX1 of the inspection image included in the set of data points P2 used in the learning flow. The decider 23 does not have to have the capability of calculating the provisional boundary. In that case, the inspection system 2 may communicate with the processing system 1 to make the boundary definer 13 calculate the provisional boundary with the data point PX1 of the inspection image included in the set of data points P2.

Then, the decider 23 determines whether the provisional boundary defined by adding the data point PX1 of the inspection image has changed from the original convex hull boundary B1. That is to say, if the provisional boundary is different from the original convex hull boundary B1 as a result of the comparison (i.e., if there is any change), then the data point PX1 would have fallen outside of the convex hull boundary B1, and therefore, would have been recognized as a new vertex, thus causing the boundary to be updated. On the other hand, if the provisional boundary is the same as the original convex hull boundary B1 as a result of comparison (i.e., if there is no change), then the data point PX1 would have fallen within the convex hull boundary B1 as the criterion, and therefore, would not have been recognized as a new vertex, thus causing the boundary not to be updated. Thus, by determining whether there is any such change, the decider 23 decides, if there is any change, that the data point PX1 should fall outside of the convex hull boundary B1 and decides, if there is no change, that the data point PX1 should fall within the convex hull boundary B1. Employing such a decision technique may reduce the chances of the computational logic becoming too complicated.

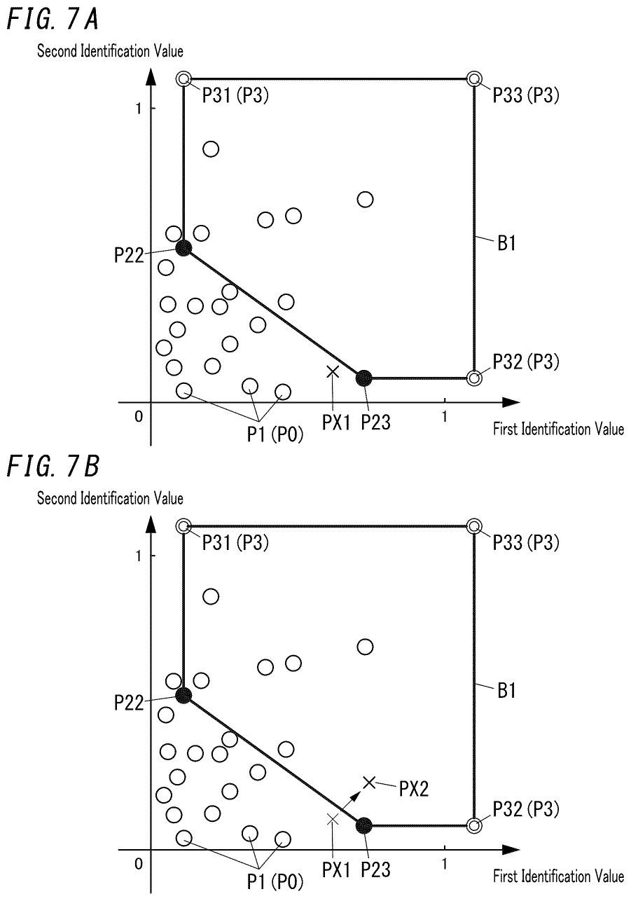

Meanwhile, as already described with respect to the learning flow, unless a sufficient number of defective image data sets DS1 are prepared in advance, there may be an inspection image which causes an identification value slightly less than the convex hull boundary B1 to be output (refer to the data point PX1 shown in FIG. 7A). That is to say, in that case, an erroneous decision may be made (i.e., a defective product may be missed) due to the shortage of defective image data.

In the foregoing description of the learning flow, the criterion adjuster 15 provided for the processing system 1 adjusts the criterion by making a predetermined margin adjustment to the convex hull boundary B1, thereby reducing the risk of missing a defective product.

Optionally, instead of (or in addition to) making the margin adjustment to the convex hull boundary B1 on the processing system 1 end, a margin adjustment may also be made on the inspection system 2 end, for example. That is to say, the decider 23 may make a prescribed margin adjustment to the identification results obtained by the identification result obtainer 22 and then determine whether the appearance of the target T1 is defective or non-defective.

For example, the decider 23 may use, as a first identification value and a second identification value for decision, values calculated by multiplying the first identification value and second identification value of each inspection image by a predetermined factor greater than 1.0. Alternatively, the decider 23 may use an internally dividing point (or value) defined by internally dividing the first identification value and 1.0 by a predetermined value equal to or less than 1 as a first identification value subjected to the margin adjustment. In the same way, the decider 23 may use an internally dividing point (or value) defined by internally dividing the second identification value and 1.0 by a predetermined value equal to or less than 1 as a second identification value subjected to the margin adjustment. Specifically, if ε=10⁻³, the identification value before being subjected to the margin adjustment is u, and the identification value subjected to the margin adjustment is R, for example, then the decider 23 may obtain R by the equation β=α+(1−α)×ε. FIG. 7B shows a data point PX1 corresponding to a first identification value and a second identification value that have not been multiplied by the predetermined factor yet (i.e., before being subjected to the margin adjustment) and a data point PX2 corresponding to a first identification value and a second identification value that have already been multiplied by the predetermined factor (i.e., after having been subjected to the margin adjustment). The data point PX1 that has not been subjected to the margin adjustment yet falls outside of the convex hull boundary B1, and therefore, an actually defective target T1 will be finally recognized as a non-defective one. On the other hand, the data point PX2 that has been subjected to the margin adjustment falls within the convex hull boundary B1, and therefore, the target T1 will be finally recognized as a defective one.

As can be seen, making the predetermined margin adjustment to the identification result allows the go/no-go decision to be made with more reliability. As a result, this reduces the chances of missing any defective product.

According to the present disclosure, the margin adjustment does not have to be made to the identification result. Rather, a command is preferably acceptable via at least one user interface (input device) such as a mouse, a keyboard, or a pointing device provided for the inspection system 2 as to whether the margin adjustment needs to be made or not (i.e., whether the margin adjustment should be enabled or disabled). The input device of the inspection system 2 may be the input device 16 of the processing system 1. In addition, a command is also preferably acceptable via the input device as to whether the predetermined factor, for example, should be changed. Information about the setting of the margin adjustment is stored in the storage device 24.

The inspection result notifier 25 notifies the inspector of the decision result obtained by the decider 23. The inspection result notifier 25 may be a surveillance monitor, for example, or a communications device (such as a desktop computer, a laptop computer, a tablet computer, or a smartphone) used by the inspector. The inspection result notifier 25 may be the display device 17 of the processing system 1. The inspection result notifier 25 may notify the inspector of all decision results, no matter whether the decision result indicates that the target T1 is defective or non-defective. However, this would make the amount of information transmitted so large as to make the notification annoying. Thus, the inspection result notifier 25 may issue an alert message only when the decision result indicates that the target T1 is defective. Alternatively, the notification may also be made by emitting an alert sound from a loudspeaker, for example. The inspection result notifier 25 preferably provides information (such as a product serial number) that allows the inspector to identify the target T1 which has turned out to be defective as a result of the decision. Still alternatively, the inspection result notifier 25 may make notification by displaying, on the screen, the image data IM1 (inspection image) indicating that the target T1 has turned out to be defective as a result of the decision. Note that every decision result is preferably stored as log information in the storage device 24, no matter whether the target T1 turns out to be defective or non-defective.

In addition, the inspection system 2 also transmits a signal to management equipment for managing the production line to discard the target T1 that has turned out to be defective as a result of the decision, temporarily stop running the carrier to allow the inspector to make a visual check of the target T1, or transfer the target T1 to a storage place where the target T1 is to be checked visually.

### (2.4) Operation of Processing System

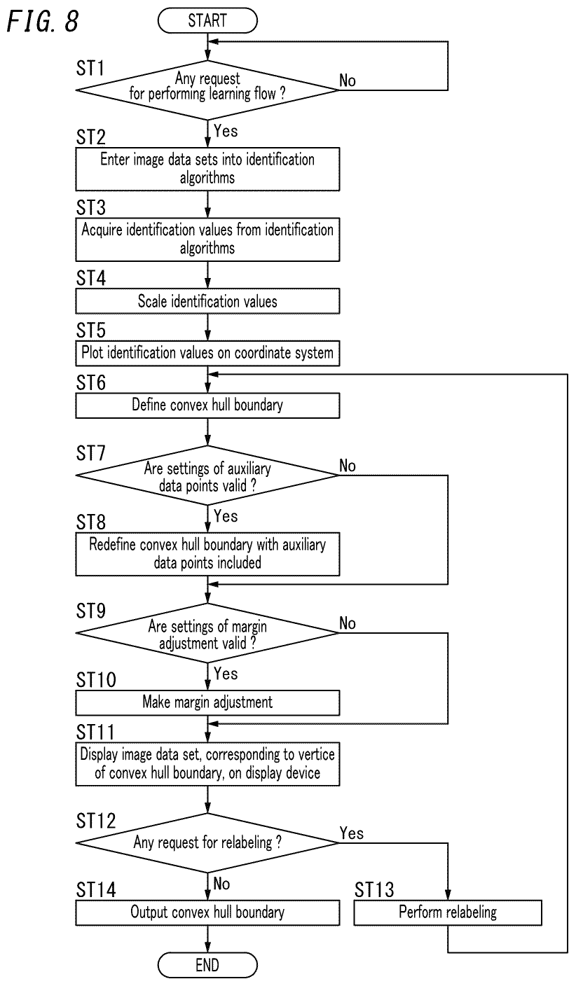

Next, an exemplary operation of the processing system 1 (its operation on the learning flow) will be described briefly with reference to the flowchart shown in FIG. 8. Note that the order in which the respective processing steps are performed as shown in FIG. 8 is only an example and should not be construed as limiting. Optionally, some of the processing steps to be described below may be omitted as appropriate and/or an additional processing step may be performed as needed.

For example, on receiving a request for performing the learning flow from the operator via the input device 16 (if the answer is YES in Step ST1), the processing system 1 performs the learning flow (i.e., the process proceeds to the next Step ST2). Otherwise, the processing system 1 stands by without performing the learning flow until the processing system 1 accepts a request for performing the learning flow from the operator (if the answer is NO in Step ST1).

The processing system 1 makes the algorithm processor 12 enter a plurality of image data sets DS1 that have been prepared in advance into the plurality of identification algorithms A0 (in Step ST2). Then, the processing system 1 acquires as many identification values output by the identification algorithms A0 with respect to each image data set DS1 as the plurality of identification algorithms A0 (in Step ST3).

Next, the processing system 1 makes the boundary definer 13 scale each of the identification values thus acquired to a numerical value falling within the range from 0.00 to 1.00 (in Step ST4). Then, the processing system 1 makes the boundary definer 13 plot out the plurality of identification values thus scaled on a coordinate system with multiple axes (in Step ST5).

The processing system 1 makes the boundary definer 13 define a convex hull boundary B1 based on the identification values (i.e., a set of data points P2) corresponding to the plurality of image data sets DS1, to which a label indicating the second category (defective) is attached (in Step ST6).

The processing system 1 makes the boundary definer 13 confirm whether the setting of the auxiliary data points plotted is valid or invalid (in Step ST7). When finding the setting of the auxiliary data points plotted valid (if the answer is YES in Step ST7), the processing system 1 redefines the convex hull boundary B1 with the auxiliary set of data points P3 included in the set of data points P2 to which the label indicating the second category is attached (in Step ST8). On the other hand, when finding the setting of the auxiliary data points plotted invalid (if the answer is NO in Step ST7), the processing system 1 skips Step ST8. Alternatively, Step ST7 may be performed before Step ST6.

The processing system 1 makes the criterion adjuster 15 confirm whether the settings of the margin adjustment are valid or invalid (in Step ST9). When finding the settings of the margin adjustment valid (if the answer is YES in Step S9), the processing system 1 makes a predetermined margin adjustment to the convex hull boundary B1 (in Step ST10). On the other hand, when finding the settings of the margin adjustment invalid (if the answer is NO in Step ST9), the processing system 1 skips Step ST10. Alternatively, Step ST9 may be performed before Step ST6.

The processing system 1 makes the display processor 14 have a particular image data set DS1, plotted as a set of data points P2 corresponding to the vertices of the convex hull boundary B1, displayed on the display device 17 (in Step ST11).

The operator visually checks the particular image data set DS1 displayed on the display device 17 to determine whether the label attached is correct or wrong and gives an answer including the decision result via the input device 16. The processing system 1 determines, in accordance with the answer, whether a request for relabeling has been made or not (in Step ST12).

When deciding that the request for relabeling has been made (if the answer is YES in Step S12), the processing system 1 performs relabeling (in Step 1ST13). That is to say, the processing system 1 changes the label attached to the particular image data set DS1 in question from the label indicating the second category (defective) into the one indicating the first category (non-defective). After that, the processing system 1 goes back to Step ST6 to make the boundary definer 13 define the convex hull boundary B1 all over again.

When deciding that no request for relabeling has been made (if the answer is NO in Step ST12), the processing system 1 does not perform relabeling but fixes the convex hull boundary B1. Then, the processing system 1 makes the output processor 11 output criterion information D1, including information about the convex hull boundary B1 thus fixed, to the inspection system 2 (in Step ST14). In other words, the processing method according to this embodiment includes an output processing step including outputting the criterion information D1 including information about the convex hull boundary B1 to be applied to the inspection algorithm performed by the inspection system 2.

### (2.5) Operation of Inspection System

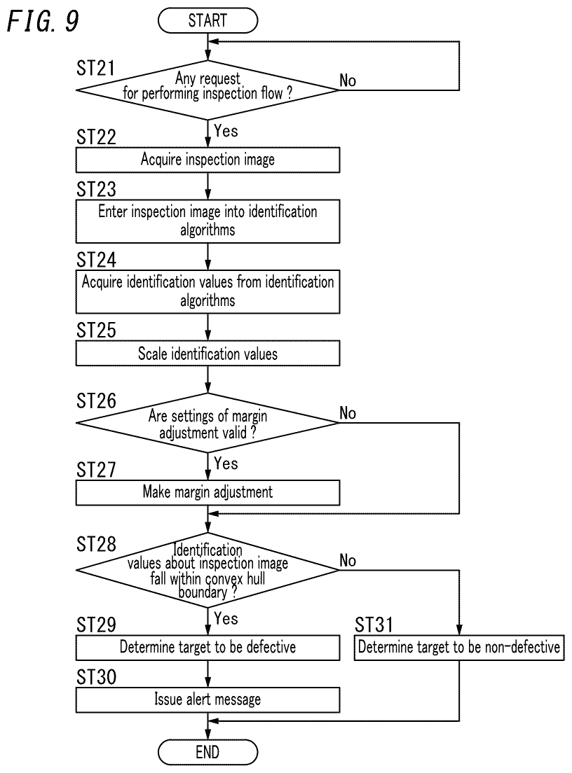

Next, an exemplary operation of the inspection system 2 (its operation on the inspection flow) will be described briefly with reference to the flowchart shown in FIG. 9. Note that the order in which the respective processing steps are performed as shown in FIG. 9 is only an example and should not be construed as limiting. Optionally, some of the processing steps to be described below may be omitted as appropriate and/or an additional processing step may be performed as needed.

For example, on receiving a request for performing the inspection flow from the inspector via the input device of the inspection system 2 (if the answer is YES in Step ST21), the inspection system 2 performs the inspection flow (i.e., the process proceeds to the next Step ST22). Otherwise, the inspection system 2 stands by without performing the inspection flow until the inspection system 2 accepts a request for performing the inspection flow from the inspector (if the answer is NO in Step ST21).

The image capturing unit 3 captures, in the inspection flow, the images of targets T1 which are sequentially transported one after another by a carrier such as a conveyor. The inspection system 2 makes the image acquirer 21 acquire the image data IM1 (inspection image) in real time as needed from the image capturing unit 3 (in Step ST22).

The inspection system 2 makes the identification result obtainer 22 enter the inspection images thus acquired into the plurality of identification algorithms A0 (in Step ST23). Then, the inspection system 2 acquires as many identification values corresponding to the inspection images as the plurality of identification algorithms A0 (in Step ST24).

Next, the inspection system 2 makes the decider 23 scale each of the identification values thus acquired to a numerical value falling within the range from 0.00 to 1.00 (in Step ST25).

Furthermore, the inspection system 2 makes the decider 23 confirm whether the settings of the margin adjustment are valid or invalid (in Step ST26). When finding the settings of the margin adjustment valid (if the answer is YES in Step ST26), the inspection system 2 makes a margin adjustment on a plurality of identification values (plotted as data points PX1) about the inspection image (in Step ST27). On the other hand, when finding the settings of the margin adjustment invalid (if the answer is NO in Step ST26), the inspection system 2 skips Step ST27.

The inspection system 2 makes the decider 23 determine whether the plurality of identification values about the inspection image (plotted as either the data points PX1 or the data points PX2 subjected to the margin adjustment) fall within, or outside of, the convex hull boundary B1 (in Step ST28).

When deciding that the plurality of identification values about the inspection image (plotted as either the data points PX1 or the data points PX2) should fall within the convex hull boundary B1 (if the answer is YES in Step ST28), the inspection system 2 determines the target T1 covered by the inspection image to be defective (in Step ST29). Then, the inspection system 2 makes the inspection result notifier 25 issue an alert message indicating that the decision result is “defective” (in Step ST30). In addition, the inspection system 2 also transmits a signal to management equipment for managing the production line to perform the predetermined processing (such as discarding the target T1 or temporarily stopping running the carrier) as described above.

On the other hand, when deciding that the plurality of identification values about the inspection image (plotted as either the data points PX1 or the data points PX2) fall outside of the convex hull boundary B1 (if the answer is NO in Step ST28), the inspection system 2 determines the target T1 covered by the inspection image to be non-defective (in Step ST31). In that case, the inspection system 2 issues no alert message.

### Advantages

The processing system 1 according to this embodiment includes an output processor 11 that outputs criterion information D1 including information about a decision boundary as a convex hull boundary B1. This reduces the chances of a target T1 which should actually be classified into the first category (e.g., recognized as a non-defective product) being erroneously classified into the second category (e.g., recognized as a defective product). Consequently, this processing system 1 achieves the advantage of contributing to reducing the overdetection rate.

An image data set DS1 to be classified into the second category (defective) may have identification values concentrated to a certain degree around 1. Thus, the set of data points P2 to be classified into the second category may have a dense part around 1 and a sparse part around the center as shown in FIG. 3A, for example. However, even if t the given set of data points P2 is classified into the second category, including such a sparse part around the center thereof, setting the convex hull boundary B1 may also reduce the risk of taking, by mistake, the target T1 that should be classified into the second category (defective) for a target T1 to be classified into the first category (non-defective) (i.e., may reduce the chances of missing a defective product).

In addition, the processing system 1 makes the algorithm processor 12 automatically enter the plurality of image data sets DS1 into the plurality of identification algorithms A0 to output the identification results obtained by the plurality of identification algorithms A0. Thus, there is no need to provide, outside of the processing system 1, any constituent element for entering the plurality of image data sets DS1 into the plurality of identification algorithms A0.

Furthermore, the processing system 1 makes the boundary definer 13 automatically define the convex hull boundary B1. This makes it easier to output the criterion information D1 in a more reliable form than, for example, in a situation where the operator defines the convex hull boundary B1 based on the identification results. In addition, this may also save the operator the trouble of defining the convex hull boundary B1 by him- or herself.

In the inspection system 2 according to this embodiment, the decider 23 makes a decision about the category based on the positional relationship between the identification results obtained by the identification result obtainer 22 and the convex hull boundary B1. This reduces the chances of the target T1 that should actually be classified into the first category (non-defective) being classified into the second category (defective). Consequently, the inspection system 2 achieves the advantage of contributing to reducing the overdetection rate.

Furthermore, the decider 23 decides, when finding the identification results obtained by the identification result obtainer 22 falling within the convex hull boundary B1, that the appearance of the target T1 should be defective. On the other hand, the decider 23 decides, when finding the identification results obtained by the identification result obtainer 22 falling outside of the convex hull boundary B1, that the appearance of the target T1 should be non-defective. Consequently, the decider 23 contributes to reducing the overdetection rate when determining whether the appearance is defective or non-defective.

### (3) Variations

Note that the embodiment described above is only an exemplary one of various embodiments of the present disclosure and should not be construed as limiting. Rather, the exemplary embodiment may be readily modified in various manners depending on a design choice or any other factor without departing from the scope of the present disclosure. Optionally, the functions of the processing system 1 according to the exemplary embodiment described above may also be implemented as a processing method, a computer program, or a non-transitory storage medium that stores the computer program thereon. In addition, the functions of the inspection system 2 according to the exemplary embodiment described above may also be implemented as an inspection method, a computer program, or a non-transitory storage medium that stores the computer program thereon.

Next, variations of the exemplary embodiment will be enumerated one after another. Note that the variations to be described below may be adopted in combination as appropriate with the exemplary embodiment described above or other variations.

The processing system 1 and inspection system 2 according to the present disclosure each include a computer system. The computer system may include a processor and a memory as principal hardware components thereof. The functions of the processing system 1 and inspection system 2 according to the present disclosure are performed by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits such as an IC or an LSI include integrated circuits called a “system LSI,” a “very-large-scale integrated circuit (VLSI),” and an “ultra-large-scale integrated circuit (ULSI).” Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be aggregated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a large-scale integrated circuit.

In the embodiment described above, the plurality of functions of the processing system 1 are integrated together in a single housing. However, this is not an essential configuration for the processing system 1 and should not be construed as limiting. Alternatively, those constituent elements of the processing system 1 may be distributed in multiple different housings. Specifically, the function of the algorithm processor 12 may be provided for an external device (e.g., a cloud server) and the other functions of the processing unit 10 (such as the function of the boundary definer 13) may be provided for a device in an edge environment such as a factory.

In the embodiment described above, the plurality of functions of the inspection system 2 are integrated together in a single housing. However, this is not an essential configuration for the inspection system 2 and should not be construed as limiting. Alternatively, those constituent elements of the inspection system 2 may be distributed in multiple different housings. Specifically, the function of the identification result obtainer 22 may be provided for an external device (e.g., a cloud server) and the other functions of the processing unit 20 (such as the function of the decider 23) may be provided for a device in an edge environment such as a factory.

Conversely, the plurality of functions of the processing system 1 may be integrated together in a single housing as in the exemplary embodiment described above. Furthermore, at least some functions of the processing system 1 (e.g., some functions of the processing system 1) may be implemented as, for example, a cloud computing system as well. Also, the plurality of functions of the inspection system 2 may be integrated together in a single housing as in the exemplary embodiment described above. Furthermore, at least some functions of the inspection system 2 (e.g., some functions of the inspection system 2) may be implemented as, for example, a cloud computing system as well.

Optionally, at least some functions of the processing system 1 and at least some functions of the inspection system 2 may be performed by the same processor. Specifically, the function of the boundary definer 13 of the processing system 1 and the function of the decider 23 of the inspection system 2 may be performed by the same processor.

In the exemplary embodiment described above, the auxiliary set of data points P3 is a set of data points in which the coordinate values are a combination of a minimum value of the identification values output by the plurality of identification algorithms A0, respectively, with respect to the set of data points P2 with the label indicating the second category attached and a value equal to or greater than the upper limit value of the predetermined range (from 0 to 1). However, this is only an exemplary method for plotting the auxiliary set of data points P3 and should not be construed as limiting. Alternatively, for example, any of the intersections between the convex hull boundary B1 (or an extension of a “side” which forms part of the boundary B1 or an extension of a “face” which forms part of the boundary B1) and the boundary of the predetermined range may be set as the auxiliary data point P3. The boundary of the predetermined range is made up of, if the predetermined range is from 0 to 1, a first line connecting the origin (0, 0) to (0, 1), a second line connecting (0, 1) to (1.1), a third line connecting (1, 1) to (1, 0), and a fourth line connecting the origin (0, 0) to (1, 0) in the case of a two-dimensional one. Still alternatively, any of the intersections between the convex hull boundary B1 (or an extension of a “side” which forms part of the boundary B1 or an extension of a “face” which forms part of the boundary B1) and the boundary of an area larger than the predetermined range may be set as the auxiliary data point P3.

In the exemplary embodiment described above, the higher the identification value is, the more likely the target T1 is supposed to be classified into the second category (recognized as a defective product). However, this is only an example and should not be construed as limiting. Alternatively, the higher the identification value is, the more likely the target T1 may be classified into the first category (recognized as a non-defective product). In that case, the boundary definer 13 may plot, on a coordinate system with multiple axes, a coordinate value including a value equal to or less than the lower limit value of the predetermined range as the auxiliary data point P3.

### (4) Recapitulation

As can be seen from the foregoing description, a processing system (1) according to a first aspect includes an output processor (11) which outputs criterion information (D1). The criterion information (D1) is applicable to an inspection algorithm for use to inspect the target (T1) based on image data (IM1) of a target (T1) and thereby identify a category of the target (T1). The criterion information (D1) includes information about a decision boundary to be defined based on identification results obtained by a plurality of identification algorithms (A0) that are different from each other. The decision boundary is used as a criterion for determining, by the inspection algorithm, whether the category of the target (T1) is a first category or a second category. Each of the plurality of identification algorithms (A0) identifies, in response to entry of a plurality of image data sets (DS1), each representing the target (T1), the category with respect to each of the plurality of image data sets (DS1). A label indicating either the first category or the second category is attached to each of the plurality of image data sets (DS1). The decision boundary is a convex hull boundary (B1) to be defined based on a set of corresponding identification results, belonging to the identification results, about an image data set (DS1), to which the label indicating the second category is attached, out of the plurality of image data sets (DS1).

According to this aspect, the processing system (1) includes an output processor (11) which outputs criterion information (D1) including information about a decision boundary as a convex hull boundary (B1). This reduces the chances of a target (T1) which should actually be classified into the first category (e.g., recognized as a non-defective product) being erroneously classified into the second category (e.g., recognized as a defective product). Consequently, this processing system (1) achieves the advantage of contributing to reducing the overdetection rate.

A processing system (1) according to a second aspect, which may be implemented in conjunction with the first aspect, further includes an algorithm processor (12). The algorithm processor (12) enters the plurality of image data sets (DS1) into the plurality of identification algorithms (A0) and outputs the identification results obtained by the plurality of identification algorithms (A0).

This aspect eliminates the need to provide a constituent element for entering, outside of the processing system (1), the plurality of image data sets (DS1) into the plurality of identification algorithms (A0).

In a processing system (1) according to a third aspect, which may be implemented in conjunction with the first or second aspect, the criterion information (D1) includes information about at least one selected from the group consisting of vertices, sides, and faces that form the convex hull boundary (B1).

This aspect makes it easier to output the criterion information (D1) in a highly reliable form.

A processing system (1) according to a fourth aspect, which may be implemented in conjunction with any one of the first to third aspects, further includes a boundary definer (13). The boundary definer (13) defines the convex hull boundary (B1) based on the corresponding identification results obtained with respect to the image data set (DS1), to which the label indicating the second category is attached, out of the plurality of image data sets (DS1).

This aspect allows the processing system (1) to automatically define the convex hull boundary (B1), thus making it easier to output the criterion information (D1) in a more reliable form than in a situation where the user defines the convex hull boundary (B1) based on the identification results, for example. In addition, this also makes it easier to save the user the trouble of defining the convex hull boundary (B1).

In a processing system (1) according to a fifth aspect, which may be implemented in conjunction with any one of the first to fourth aspects, the category is a category indicating whether appearance of the target (T1) is defective or non-defective.

This aspect contributes to reducing the overdetection rate when determining whether the appearance is defective or non-defective.

In a processing system (1) according to a sixth aspect, which may be implemented in conjunction with the fifth aspect, the first category is a category indicating that the appearance of the target (T1) is non-defective, and the second category is a category indicating that the appearance of the target (T1) is defective.

This aspect reduces the chances of the target (T1) which actually has non-defective appearance being recognized erroneously as a defective product.

In a processing system (1) according to a seventh aspect, which may be implemented in conjunction with any one of the first to sixth aspects, the plurality of identification algorithms (A0) output, with respect to the plurality of image data sets (DS1), identification values as the identification results. The identification values are numerical values indicating a probability that the target (T1) is classified into either the first category or the second category.

This aspect makes it easier to output, in a highly reliable form, the identification results obtained by the plurality of identification algorithms (A0).

A processing system (1) according to an eighth aspect, which may be implemented in conjunction with the seventh aspect, further includes a boundary definer (13). The boundary definer (13) defines the convex hull boundary (B1) based on the corresponding identification results obtained with respect to the image data set (DS1), to which the label indicating the second category is attached, out of the plurality of image data sets (DS1). The boundary definer (13) plots out, on a coordinate system with multiple axes, the identification values output by the plurality of identification algorithms (A0) with respect to the plurality of image data sets (DS1). The boundary definer (13) defines the convex hull boundary (B1) to be a boundary serving as a convex set, of which vertices are defined by data points (P2: P21-P29) belonging to a set of data points (P2), having the label indicating the second category attached, out of a plurality of data points (P0) respectively corresponding to the plurality of image data sets (DS1).

This aspect allows the processing system (1) to automatically define the convex hull boundary (B1) even more easily.

In a processing system (1) according to a ninth aspect, which may be implemented in conjunction with the eighth aspect, the identification values output by the plurality of identification algorithms (A0), respectively, are either values falling within a predetermined range or scaled by the boundary definer (13) to fall within the predetermined range.

This aspect reduces the chances of causing an increase in dispersion (bias) among the identification values calculated by the respective identification algorithms (A0), thus allowing the processing system (1) to automatically define the convex hull boundary (B1) even more easily.

In a processing system (1) according to a tenth aspect, which may be implemented in conjunction with the ninth aspect, the boundary definer (13) plots, on the coordinate system with the multiple axes, coordinate values, including values equal to or greater than an upper limit value of the predetermined range, as an auxiliary set of data points (P3). The boundary definer (13) defines the convex hull boundary (B1) with the auxiliary set of data points (P3) included additionally in the set of data points (P2) to which the label indicating the second category is attached.

An identification result obtained by one identification algorithm (A0) may indicate, for example, that the target (T1) covered by one inspection image is highly likely to be classified into the second category (e.g., recognized as a defective product). Nevertheless, an identification result obtained by another identification algorithm (A0) may indicate that the target (T1) covered by that inspection image is highly likely to be classified into the first category (e.g., recognized as a non-defective product). In that case, the second category may be missed due to overlearning that causes the target (T1) that should be classified into the second category (e.g., recognized as a defective product) to be erroneously classified into the first category (e.g., recognized as a non-defective product). According to this aspect, setting those coordinate values as an auxiliary set of data points (P3) may reduce the chances of making such an erroneous decision (missing) due to the overlearning. In addition, this aspect may also simplify the inspection algorithm so much as to contribute to shortening the time it takes to make a decision by the inspection algorithm.

In a processing system (1) according to an eleventh aspect, which may be implemented in conjunction with the tenth aspect, the auxiliary set of data points (P3) is a set of data points in which coordinate values on the coordinate system with the multiple axes are a combination of a minimum value of the identification values output by the plurality of identification algorithms (A0), respectively, with respect to the set of data points (P2), to which the label indicating the second category is attached, and the values equal to or greater than the upper limit value of the predetermined range.

This aspect further reduces the chances of making an erroneous decision (missing) due to the overlearning. In addition, this aspect may further shorten the time it takes to make a decision by the inspection algorithm.

A processing system (1) according to a twelfth aspect, which may be implemented in conjunction with any one of the eighth to eleventh aspects, further includes a display processor (14) and an input device (16). The display processor (14) makes a display device (17) display an image data set (DS1) belonging to the plurality of image data sets (DS1) which corresponds to data points (P2: P21-P29) representing the vertices. The input device (16) accepts entry of relabeling with respect to the label attached to the image data set (DS1) displayed. The boundary definer (13) updates the convex hull boundary (B1) in accordance with a result of relabeling accepted by the input device (16). The output processor (11) outputs the criterion information (D1) including the convex hull boundary (B1) that has been updated.

This aspect allows, when there is any wrong label, the user to make correction efficiently. In addition, this aspect may also increase the reliability of the convex hull boundary (B1).

A processing system (1) according to a thirteenth aspect, which may be implemented in conjunction with any one of the first to twelfth aspects, further includes a criterion adjuster (15). The criterion adjuster (15) adjusts the criterion by making a predetermined margin adjustment with respect to the convex hull boundary (B1) to expand an area surrounded with the convex hull boundary (B1).

This aspect makes it easier to output more reliable criterion information (D1). For example, this aspect may reduce the risk of missing.

An inspection system (2) according to a fourteenth aspect performs the inspection algorithm to which the criterion information (D1) provided by the processing system (1) according to any one of the first to thirteenth aspects is applied. The inspection system (2) includes an image acquirer (21), an identification result obtainer (22), and a decider (23). The image acquirer (21) acquires the image data (IM1) of the target (T1). The identification result obtainer (22) obtains identification results from the plurality of identification algorithms (A0) by entering the image data (IM1) acquired by the image acquirer (21) into the plurality of identification algorithms (A0). The decider (23) makes a decision about the category based on a positional relationship between the identification results obtained by the identification result obtainer (22) and the convex hull boundary (B1) of the criterion information (D1).

This aspect reduces the chances of a target (T1) which should actually be classified into the first category (e.g., recognized as a non-defective product) being erroneously classified into the second category (e.g., recognized as a defective product). Consequently, this inspection system (2) achieves the advantage of contributing to reducing the overdetection rate.

In an inspection system (2) according to a fifteenth aspect, which may be implemented in conjunction with the fourteenth aspect, the category is a category indicating whether appearance of the target (T1) is defective or non-defective. The first category is a category indicating that the appearance of the target (T1) is non-defective. The second category is a category indicating that the appearance of the target (T1) is defective. The decider (23) decides, when the positional relationship indicates that one of the identification result obtained by the identification result obtainer (22) falls within the convex hull boundary (B1), that the appearance of the target (T1) is defective. The decider (23) decides, when the positional relationship indicates that another one of the identification result obtained by the identification result obtainer (22) falls outside of the convex hull boundary (B1), that the appearance of the target (T1) is non-defective.

This aspect contributes to reducing the overdetection rate when determining whether the appearance is defective or non-defective.

In an inspection system (2) according to a sixteenth aspect, which may be implemented in conjunction with the fourteenth or fifteenth aspect, the decider (23) determines, after having made a predetermined margin adjustment with respect to the identification results obtained by the identification result obtainer (22), whether the appearance of the target (T1) is defective or non-defective.

This aspect enables making a go/no-go decision with more reliability. For example, this aspect reduces the chances of missing.

A processing method according to a seventeenth aspect includes an output processing step including outputting criterion information (D1). The criterion information (D1) is applicable to an inspection algorithm for use to inspect the target (T1) based on image data of a target (T1) and thereby identify a category of the target (T1). The criterion information (D1) includes information about a decision boundary to be defined based on identification results obtained by a plurality of identification algorithms (A0) that are different from each other. The decision boundary is used as a criterion for determining, by the inspection algorithm, whether the category of the target (T1) is a first category or a second category. Each of the plurality of identification algorithms (A0) identifies, in response to entry of a plurality of image data sets (DS1), each representing the target (T1), the category with respect to each of the plurality of image data sets (DS1). A label indicating either the first category or the second category is attached to each of the plurality of image data sets (DS1). The decision boundary is a convex hull boundary (B1) to be defined based on a set of corresponding identification results, belonging to the identification results, about an image data set (DS1), to which the label indicating the second category is attached, out of the plurality of image data sets (DS1).

This aspect may provide a processing method contributing to reducing the overdetection rate.

A program according to an eighteenth aspect is designed to cause one or more processors to perform the processing method according to the seventeenth aspect.

This aspect may provide a function contributing to reducing the overdetection rate.

Note that the constituent elements according to the second to thirteenth aspects are not essential constituent elements for the processing system (1) according to the first aspect but may be omitted as appropriate. Note that the constituent elements according to the fifteenth and sixteenth aspects are not essential constituent elements for the inspection system (2) according to the fourteenth aspect but may be omitted as appropriate.

### REFERENCE SIGNS LIST

1 Processing System
11 Output Processor
12 Algorithm Processor
13 Boundary Definer
14 Display Processor
15 Criterion Adjuster
16 Input Device
17 Display Device
2 Inspection System
21 Image Acquirer
22 Identification Result Obtainer
23 Decider
A0 Identification Algorithm
B1 Convex Hull Boundary
D1 Criterion Information
DS1 Image Data Set
IM1 Image Data
P0, P2 Data Point
P3 Auxiliary Data Point
T1 Target

1. A processing system comprising an output processor configured to output criterion information, the criterion information being applicable to an inspection algorithm for use to inspect a target based on image data of the target and thereby identify a category of the target,
the criterion information including information about a decision boundary to be defined based on identification results obtained by a plurality of identification algorithms that are different from each other, the decision boundary being used as a criterion for determining, by the inspection algorithm, whether the category of the target is a first category or a second category,
each of the plurality of identification algorithms being configured to, in response to entry of a plurality of image data sets, each representing the target, identify the category with respect to each of the plurality of image data sets,
a label indicating either the first category or the second category being attached to each of the plurality of image data sets, and
the decision boundary being a convex hull boundary to be defined based on a set of corresponding identification results, belonging to the identification results, about an image data set,
to which the label indicating the second category is attached, out of the plurality of image data sets.

2. The processing system of claim 1, further comprising an algorithm processor configured to enter the plurality of image data sets into the plurality of identification algorithms and output the identification results obtained by the plurality of identification algorithms.

3. The processing system of claim 1, wherein
the criterion information includes information about at least one selected from the group consisting of vertices, sides, and faces that form the convex hull boundary.

4. The processing system of claim 1, further comprising a boundary definer configured to define the convex hull boundary based on the corresponding identification results obtained with respect to the image data set, to which the label indicating the second category is attached, out of the plurality of image data sets.

5. The processing system of claim 1, wherein
the category is a category indicating whether appearance of the target is defective or non-defective.

6. The processing system of claim 5, wherein
the first category is a category indicating that the appearance of the target is non-defective, and
the second category is a category indicating that the appearance of the target is defective.

7. The processing system of claim 1, wherein
the plurality of identification algorithms are configured to output, with respect to the plurality of image data sets, identification values as the identification results, the identification values being numerical values indicating a probability that the target is classified into either the first category or the second category.

8. The processing system of claim 7, further comprising a boundary definer configured to define the convex hull boundary based on the corresponding identification results obtained with respect to the image data set, to which the label indicating the second category is attached, out of the plurality of image data sets, wherein
the boundary definer is configured to plot out, on a coordinate system with multiple axes, the identification values output by the plurality of identification algorithms with respect to the plurality of image data sets and define the convex hull boundary to be a boundary serving as a convex set, of which vertices are defined by data points belonging to a set of data points having the label indicating the second category attached, out of a plurality of data points respectively corresponding to the plurality of image data sets.

9. The processing system of claim 8, wherein
the identification values output by the plurality of identification algorithms, respectively, are either values falling within a predetermined range or scaled by the boundary definer to fall within the predetermined range.

10. The processing system of claim 9, wherein
the boundary definer is configured to plot out, on the coordinate system with the multiple axes, coordinate values, including values equal to or greater than an upper limit value of the predetermined range, as an auxiliary set of data points, and
the boundary definer is configured to define the convex hull boundary with the auxiliary set of data points included additionally in the set of data points, to which the label indicating the second category is attached.

11. The processing system of claim 10, wherein
the auxiliary set of data points is a set of data points in which coordinate values on the coordinate system with the multiple axes are a combination of a minimum value of the identification values output by the plurality of identification algorithms, respectively, with respect to the set of data points, to which the label indicating the second category is attached, and the values equal to or greater than the upper limit value of the predetermined range.

12. The processing system of claim 8, further comprising:
a display processor configured to make a display device display an image data set belonging to the plurality of image data sets which corresponds to data points representing the vertices; and
an input device configured to accept entry of relabeling with respect to the label attached to the image data set displayed, wherein
the boundary definer is configured to update the convex hull boundary in accordance with a result of relabeling accepted by the input device, and
the output processor is configured to output the criterion information including the convex hull boundary that has been updated.

13. The processing system of claim 1, further comprising a criterion adjuster configured to adjust the criterion by making a predetermined margin adjustment with respect to the convex hull boundary to expand an area surrounded with the convex hull boundary.

14. An inspection system configured to perform the inspection algorithm to which the criterion information provided by the processing system of claim 1 is applied, the inspection system comprising:
an image acquirer configured to acquire the image data of the target;
an identification result obtainer configured to obtain identification results from the plurality of identification algorithms by entering the image data acquired by the image acquirer into the plurality of identification algorithms; and
a decider configured to make a decision about the category based on a positional relationship between the identification results obtained by the identification result obtainer and the convex hull boundary of the criterion information.

15. The inspection system of claim 14, wherein
the category is a category indicating whether appearance of the target is defective or non-defective,
the first category is a category indicating that the appearance of the target is non-defective,
the second category is a category indicating that the appearance of the target is defective, and
the decider is configured to,
decide, when the positional relationship indicates that one of the identification results obtained by the identification result obtainer falls within the convex hull boundary, that the appearance of the target is defective, and
decide, when the positional relationship indicates that another one of the identification results obtained by the identification result obtainer falls outside of the convex hull boundary, that the appearance of the target is non-defective.

16. The inspection system of claim 14, wherein
the decider is configured to determine, after having made a predetermined margin adjustment with respect to the identification results obtained by the identification result obtainer, whether the appearance of the target is defective or non-defective.

17. A processing method comprising:
an output processing step including outputting criterion information, the criterion information being applicable to an inspection algorithm for use to inspect a target based on image data of the target and thereby identify a category of the target,
the criterion information including information about a decision boundary to be defined based on identification results obtained by a plurality of identification algorithms that are different from each other, the decision boundary being used as a criterion for determining, by the inspection algorithm, whether the category of the target is a first category or a second category,
each of the plurality of identification algorithms being configured to, in response to entry of a plurality of image data sets, each representing the target, identify the category with respect to each of the plurality of image data sets,
a label indicating either the first category or the second category being attached to each of the plurality of image data sets, and
the decision boundary being a convex hull boundary to be defined based on a set of corresponding identification results, belonging to the identification results, about an image data set, to which the label indicating the second category is attached, out of the plurality of image data sets.

18. A non-transitory computer-readable tangible recording medium storing a program designed to cause one or more processors to perform the processing method of claim 17.
